(19) United States
(12) Patent Application Publication
(10) Pub. No.: US 2025/0171312 A1
(43) Pub. Date: May 29, 2025

(54) LOW-COST CARBON NANO-ONIONS AND METHOD FOR THEIR PRODUCTION

(71) Applicant: IOWA STATE UNIVERSITY RESEARCH FOUNDATION, INC., Ames, IA (US)

(72) Inventors: Xianglan BAI, Ames, IA (US); Moham Ed Abdur RAZZAQ, Ames, IA (US); Yixin LUO, Redwood City, CA (US)

(21) Appl. No.: 18/962,867

(22) Filed: Nov. 27, 2024

Related U.S. Application Data
(60) Provisional application No. 63/603,725, filed on Nov. 29, 2023.

(51) Int. Cl. C01B 32/18; C08K 13/04

(52) U.S. Cl. CPC C01B 32/18; C08K 13/04; C01P 2002/01; C01P 2002/72; C01P 2002/82; C01P 2002/85; C01P 2002/88; C01P 2004/03; C01P 2004/04; C01P 2004/51; C08K 2201/011

(57) ABSTRACT

One aspect of the present disclosure relates to a carbon nano-onion comprising a structure comprising a plurality of substantially concentric carbon shells. The substantially concentric carbon shells have a spherical, quasi-spherical, and/or polyhedral configuration or combinations thereof, where the substantially concentric carbon shells have surfaces functionalized with oxygen-containing functional groups. Another aspect of the present disclosure relates to a method of preparing an oxygen-functionalized carbon nano-onion. This method comprises providing a fixed carbon-containing source and treating the fixed carbon-containing source by joule heating under conditions effective to transform the fixed carbon-containing source into an oxygen-functionalized carbon nano-onion comprising a plurality of substantially concentric carbon shells. The substantially concentric carbon shells have a spherical, quasi-spherical, and/or polyhedral configuration or combinations thereof. Also disclosed is a composite material comprising the carbon nano-onion mixed with a polymer as well as a method of preparing a composite material.

This application claims the benefit of U.S. Provisional Patent Application Ser. No. 63/603,725, filed Nov. 29, 2023, which is hereby incorporated by reference in its entirety.

This invention was made with government support under OISE1826978 awarded by National Science Foundation. The government has certain rights in the invention.

### FIELD

The present application relates to low-cost carbon nano-onions and method for their production.

### BACKGROUND

Carbon materials have been crucial in human civilization's evolution and laid the foundation for numerous technological and social advancements. Coal, graphite, and activated carbon are examples of traditional carbon compounds extensively used in various industries, from water treatment to energy production. Graphene, fullerene, carbon nanotubes (CNTs), and graphdiyne are examples of novel carbon allotropes that have recently appeared and attracted substantial attention because of their distinctive architectures and extraordinary capabilities. These carbon allotropes have been widely explored in energy storage, biosensing, biology, biomedicine, photovoltaics, catalysts, environment, etc. (Wang et al., “Biomass-Derived Carbon Materials: Controllable Preparation and Versatile Applications,” Small 17(40): e2008079 (2021)).

A form of carbon nanomaterial known as a carbon nano onion (CNO) comprises several concentric carbon shells that resemble fullerenes (C₆₀) (Zeiger et al., “Review: Carbon onions for electrochemical energy storage,” J. Mater. Chem. A 4(9):3172-3196 (2016)). CNO refers to their structure; layered like an onion, CNOs are composed of closely spaced graphitic layers with quasi-spherical and polyhedral shapes, with each shell enclosing the one before it (Zeiger et al., “Review: Carbon Onions for Electrochemical Energy Storage,” J. Mater. Chem. A 4(9):3172-3196 (2016)). Depending on the synthesis process and environmental factors, they typically range in size from 2 to 200 nm (Dhand et al., “A Comprehensive Review on the Prospects of Multi-functional Carbon Nano Onions as an Effective, High-performance Energy Storage Material,” Carbon N. Y. 175:534-575 (2021)). Because of their zero dimensional nanostructure, high surface area, electric conductivity, low cytotoxicity, remarkable optoelectrical properties, CNOs have many potential applications, such as supercapacitors (Liu et al., “Hierarchical Porous Carbon Based on the Self-templating Structure of Rice Husk for High-performance Supercapacitors,” RSC Adv. 5(25):19294-19300 (2015)), electronics, biosensing (Mohapatra et al., “Enzymatic and Non-enzymatic Electrochemical Glucose Sensor Based on Carbon Nano-onions,” Appl. Surf Sci. 442:332-341 (2018)), photovoltaics, catalysis (Zhang et al., “Synthesis of Hollow Carbon Nano-onions and Their Use for Electrochemical Hydrogen Storage,” Carbon N. Y. 50(10):3513-3521 (2012)), drug delivery (Miriyala et al., “Synthesis of Carbon Onion and Its Application as a Porous Carrier For Amorphous Drug Delivery,” Crystals 10(4):281 (2020); Majumder et al., “Functionalized Carbon Nano Onion as a Novel Drug Delivery System for Brain Targeting,” J. Drug Deliv. Sci. Technol. 63(3):102414 (2021); Bartkowski and Giordani, “Carbon Nano-onions as Potential Nanocarriers for Drug Delivery,” Dalt. Trans. 50(7):2300-2309 (2021)), biomedical diagnostics (Xin et al., “Fabrication of Ultra-bright Carbon Nano-onions Via a One-step Microwave Pyrolysis of Fish Scale Waste in Seconds,” Green Chem. 24:3969 (2022)), and lubricant additives (Luo et al., “One-step Gas-liquid Detonation Synthesis of Carbon Nano-onions and Their Tribological Performance as Lubricant Additives,” Diam. Relat. Mater. 97:107448 (2019)).

Iijima published the first study on CNOs in 1980, describing how they were produced as a byproduct of carbon nanotube manufacturing (S. I. Li, “Direct Observation of the Tetrahedral Bonding in Graphitized Carbon Black By High Resolution Electron Microscopy,” J. Cryst. Growth 50:675-683 (1980)). Ugarte initially revealed the presence of the onion-structure, quasi-spherical, hollowed cage with concentric graphene layers in 1992 after exposing carbon soot to a powerful electron beam under harsh conditions (D. Ugarte, “Curling and Closure of Graphitic Networks Under Electron-beam Irradiation,” Nature 359(6397):707-709 (1992)). Since then, scientists have experimented with numerous methods to create CNOs, including high-temperature annealing of nano diamonds (Kuznetsov et al., “Onion-like Carbon From Ultra-disperse Diamond,” Chem. Phys. Lett. 222: 343-348 (1994)), arc discharge underwater (Sano et al., “Properties of Carbon Onions Produced by an Arc Discharge in Water,” J. Appl. Phys. 92(5):2783-2788 (2002)), chemical vapor deposition (CVD) (Chen et al., “New Method of Carbon Onion Growth by Radio-frequency Plasma-enhanced Chemical Vapor Deposition,” Chem. Phys. Lett. 336(3-4):201-204 (2001)), high-energy ball milling (Huang et al., “Highly Curved Carbon Nanostructures Produced by Ball-milling,” Chem. Phys. Lett. 303(1-2):130-134 (1999)), laser ablation (Dorobantu et al., “Pulse Laser Ablation System for Carbon Nano-onions Fabrication,” Surf Eng. Appl. Electrochem. 50(5):390-394 (2014); Calabro et al., “Liquid-phase Laser Ablation Synthesis of Graphene Quantum Dots From Carbon Nano-onions: Comparison With Chemical Oxidation,” J. Colloid Interface Sci. 527:132-140 (2018)), flame synthesis or pyrolysis (Mongwe et al., “Synthesis of Chain-like Carbon Nano-onions by a Flame Assisted Pyrolysis Technique Using Different Collecting Plates,” Diam. Relat. Mater. 90:135-143 (2018)), ion implantation (Cabioc'h et al., “Fourier Transform Infra-red Characterization of Carbon Onions Produced by Carbon-ion Implantation,” Chem. Phys. Lett. 285(3-4):216-220 (1998)), etc.

Kuzenetsov et al. successfully demonstrated the annealing of nanodiamonds (NDs) under vacuum and high temperatures ranging from 1500 to 2000° C., which is also the most common method to produce CNOs (Kuznetsov et al., “Onion-like Carbon From Ultra-disperse Diamond,” Chem. Phys. Lett. 222: 343-348 (1994)). Sano et al. developed an approach for producing CNOs by arc discharge when two electrodes made of graphite are submerged in water (Sano et al., “Properties of Carbon Onions Produced by an Arc Discharge in Water,” J. Appl. Phys. 92(5):2783-2788 (2002)). Another common approach for synthesizing CNO was CVD of hydrocarbon gases (methane, acetylene, and ethylene) in the presence of metal catalysts (such as nickel, iron, and cobalt) using high pressures and temperatures (Du et al., “A Facile Approach for Synthesis and In Situ Modification of Onion-like Carbon With Molybdenum Carbide,” Phys. Status Solidi Appl. Mater. Sci. 208(4):878-881 (2011); Chatterjee et al., “Nitrogen-rich Carbon Nano-onions for Oxygen Reduction Reaction,” Carbon N. Y. 130:645-651 (2018)). Alternatively, CNO was synthesized by ball-milling graphite powder mixed with an aluminum catalyst (Estrada-Guel et al., “Synthesis of Nano Carbon Onions by a Mechanical-Chemical Route,” Microsc. Microanal. 17(S2):1552-1553 (2011)), or liquid-phase laser ablation of toluene with silicon (Yang et al., “Luminescent Hollow Carbon Shells and Fullerene-like Carbon Spheres Produced by Laser Ablation With Toluene,” J. Mater. Chem. 21(12):4432-4436 (2011)). Recently, Jin et al. fabricated porous CNOs from rice husk via a multi-step process involving nickel catalyst and nitric acid (Jin et al., “Synthesis of Porous Carbon Nano-onions Derived From Rice Husk for High-performance Supercapacitors,” Appl. Surf Sci. 488:593-599 (2019)). A recent study also reported CNOs from fish scales using microwave pyrolysis (Xin et al., “Fabrication of Ultra-bright Carbon Nano-onions Via a One-step Microwave Pyrolysis of Fish Scale Waste in Seconds,” Green Chem. 24:3969 pp. 1-2 (2022)).

While CNO can be produced using several different approaches, the current synthesis of CNOs is hindered by high precursor costs and the synthesis methods often requiring costly catalysts, harsh chemicals, solvents, non-atmospheric pressures, and high energy. The scalability of the production is also constrained by these factors, making it challenging to synthesize CNOs in large quantities (Xin et al., “Fabrication of Ultra-bright Carbon Nano-onions Via a One-step Microwave Pyrolysis of Fish Scale Waste in Seconds,” Green Chem. 24:3969 (2022)). According to literature, the costs of CNOs (>$1M/ton) are several orders higher compared to other carbon materials including carbon nanotubes ($100,000/ton) and graphene nano platelets ($70,000/ton) (Liu et al., “Carbon Nano-Onions Made Directly from CO₂ by Molten Electrolysis for Greenhouse Gas Mitigation,” Adv. Sustain. Syst. 3(10):1900056 (2019)). For enabling wide applications of CNOs, a novel synthesis must be developed to significantly reduce the costs of CNOs.

The present application is directed to overcoming these and other deficiencies in the art.

### SUMMARY

One aspect of the present application relates to a carbon nano-onion comprising a structure comprising a plurality of substantially concentric carbon shells. The substantially concentric carbon shells have a spherical, quasi-spherical, and/or polyhedral configuration or combinations thereof, wherein said substantially concentric carbon shells have surfaces functionalized with oxygen-containing functional groups.

Another aspect of the present application relates to a composite material comprising the carbon non-onion disclosed herein and a polymer mixed with said carbon nano-onion.

Another aspect of the present application relates to a method of preparing an oxygen-functionalized carbon nano-onion. The method comprises providing a fixed carbon-containing source and treating the fixed carbon-containing source by joule heating under conditions effective to transform the fixed carbon-containing source into an oxygen-functionalized carbon nano-onion comprising a plurality of substantially concentric carbon shells, where said substantially concentric carbon shells have a spherical, quasi-spherical, and/or polyhedral configuration or combinations thereof.

Another aspect of the present application relates to a method of preparing a composite material. The method comprises providing the carbon nano-onion disclosed herein, blending a polymer with the carbon nano-onion to form a mixture, and forming a composite material from the mixture.

Carbon nano-onion (CNO) is a special class of carbon nanomaterials with impressive characteristics. It has been widely used in electronics, photovoltaics, energy storage, biosensing, biomedicine, and catalysts. Conventional CNO fabrication often demands costly petrochemical-based precursors, catalysts, harsh chemicals, hazardous solvent, and vacuum pressure. Due to its extremely high costs, CNO applications are limited. Herein, the joule-heating based synthesis of low-cost CNOs produced using biomass residues, such as lignin and biochar is reported. This method does not require solvent, chemicals, catalysts, or specific gas environment and can produce oxygen functionalized CNOs within short synthesis times. The CNOs produced using three different feedstocks had similar electric conductivity, similar particle sizes and crystalline structures. Their oxygen functional groups can be tuned by controlling the synthesis conditions, also showing high dispersity in various organic solvents. When the CNOs were used as additives in polylactic acid, 0.5% mass loading could increase tensile strength and modulus by 43.6% and 128.4%, respectively. When applied as additives in polymer, CNOs based on different precursors resulted in similar tensile properties in PLA, which was agnostic to the precursor origin of CNOs. Overall, this work shows a promising pathway to valorize biomass residues in an environmentally friendly, market-feasible approach.

The present application discloses a super facile and green route for synthesizing biobased low-cost CNOs using electricity alone. This non-catalytic, solvent and chemical-free approach can produce oxygen-functionalized CNOs with tunable properties from biomass residue byproducts, such as lignin and biochar. Lignin is the second most abundant biopolymer on earth, abundantly available from pulping or cellulosic biorefineries as byproducts, which the estimation of 225 million tons available by 2030. The majority of lignin is currently burned for heat and power (Ekielski and Mishra, “Lignin for Bioeconomy: The Present and Future Role of Technical Lignin,” Int. J. Mol. Sci. 22(1):1-24 (2021), which is hereby incorporated by reference in its entirety), whereas lignin valorization remains the major hurdle for emerging biorefineries. Biochar is also an abundantly available low-cost material, easily produced by biomass pyrolysis. While various biochar applications are explored, it is generally considered for soil amendments with estimated costs of $200-400/tons. Thus, making low-cost CNOs from lignin or biochar for advanced applications will greatly benefit renewable industries.

The present application discloses the production of CNOs using lignins and biochar based on a joule heating method. The biobased CNOs were characterized to show their tunable structures and properties. The CNOs were further used as an additive in polylactic acid (PLA) to produce property-advanced biopolymer nearly agnostic to the CNO precursors. PLA is the most commonly used biobased and biodegradable polymer. However, its high cost, relatively low mechanical performance, low thermal tolerance, and poor gas barrier properties relative to petroleum-based plastics hinder its market applications (Dehnou et al., “A Review: Studying the Effect of Graphene Nanoparticles on Mechanical, Physical and Thermal Properties of Polylactic Acid Polymer,” RSC Adv., 13(6):3976-4006 (2023), which is hereby incorporated by reference in its entirety). The results described herein show that CNO-engineered PLA nanocarbon composites can overcome the abovementioned weaknesses, positioning PLA for broader and advanced applications.

### BRIEF DESCRIPTION OF THE DRAWINGS

FIG. 1 illustrates a typical joule heating reactor.

FIG. 2 shows the relationship between voltage and current as a function of time.

FIG. 3 shows a schematic illustration of PLA-CNO composite preparation.

FIGS. 4A-E show TEM images for Organosolv Lignin-CNOs (OL-CNOs).

FIG. 4A shows the TEM image for carbonized lignin. FIGS. 4B-E show the TEM images for carbonized lignin with joule heating treatment for 2 min (FIG. 4B), 6 min (FIG. 4C), 8 min (FIG. 4D), and 10 min (FIG. 4E).

FIGS. 5A-D show TEM images for Kraft Lignin-CNOs (KL-CNOs). FIG. 5A shows the TEM images for carbonized lignin. FIGS. 5B-D show the TEM images for carbonized lignin with joule heating treatment for 6 min (FIG. 5B), 8 min (FIG. 5C), and 10 min (FIG. 5D).

FIGS. 6A-C show TEM images for biochar-CNOs (BC-CNOs) with joule heating treatment for 6 min (FIG. 6A), 8 min (FIG. 6B), and 10 min (FIG. 6C).

FIGS. 7A-E show SAED pattern for carbonized OL-CNOs (FIG. 7A), carbonized OL-CNOs with a treatment time of 2 min (FIG. 7B), carbonized OL-CNOs with a treatment time of 6 min (FIG. 7C), carbonized OL-CNOs with a treatment time of 8 min (FIG. 7D), and carbonized OL-CNOs with a treatment time of 10 min (FIG. 7E).

FIGS. 8A-C show particle size distribution of OL-CNOs from TEM images where the joule heating time was 6 min (FIG. 8A), 8 min (FIG. 8B), and 10 min (FIG. 8C).

FIGS. 9A-C show particle size distribution of KL-CNOs from TEM images where joule heating time was 6 min (FIG. 9A), 8 min (FIG. 9B), and 10 min (FIG. 9C).

FIGS. 10A-C show particle size distribution of BC-CNOs from TEM images where joule heating time was 6 min (FIG. 10A), 8 min (FIG. 10B), and 10 min (FIG. 10C).

FIG. 11 shows FTIR spectra for OL-CNOs.

FIG. 12 shows FTIR spectra for KL-CNOs.

FIG. 13 shows FTIR spectra for BC-CNOs.

FIGS. 14A-C show XRD spectra for OL-CNO (FIG. 14A), KL-CNO (FIG. 14B), and BC-CNO (FIG. 14C).

FIG. 15A provides a comparison of crystallite lateral size (Lₐ) and crystallite thickness (L_{c}) for OL-CNOs. FIG. 15B provides a comparison of aromaticity for OL-CNOs.

FIG. 16 provides a comparison of Raman Spectra for OL-CNOs using different treatment times.

FIG. 17 provides a comparison of Raman spectra for KL-CNOs using different treatment times.

FIG. 18 provides a comparison of Raman Spectra for BC-CNOs using different treatment times.

FIGS. 19A-B show Raman analysis for OL-CNOs produced using different treatment times. FIG. 19A shows a comparison of I_{D}/I_{G} and A_{D}/A_{G}. FIG. 19B shows a comparison of I_{2D}/I_{G}.

FIG. 20 shows the XPS survey scans for OL-CNOs.

FIG. 21 shows the XPS survey scans for KL-CNOs.

FIG. 22 shows the XPS survey scans for BC-CNOs.

FIGS. 23A-E show the deconvoluted C1s peak for OL-CNOs. FIG. 23A shows deconvoluted C1s peak for carbonized OL-CNOs. FIGS. 23B-E show deconvoluted C1s peak for carbonized OL-CNOs with treatment times of 2 min (FIG. 23B), 6 min (FIG. 23C), 8 min (FIG. 23D), and 10 min (FIG. 23E).

FIGS. 24A-E show the deconvoluted O1s peak for OL-CNOs. FIG. 24A shows the deconvoluted O1s peak for carbonized OL-CNOs. FIGS. 24B-E show deconvoluted O1s peak for carbonized OL-CNOs with treatment times of 2 min (FIG. 24B), 6 min (FIG. 24C), 8 min (FIG. 24D), and 10 min (FIG. 24E).

FIG. 25 shows a mechanism for CNO formation.

FIGS. 26A-C show dispersion of OL-CNO with 6 min treatment time after 0 hrs (FIG. 26A), 24 hrs (FIG. 26B), and 2 weeks (FIG. 26C). In FIGS. 26A-C, the OL-CNO with a 6 min treatment was dispersed in i) DI Water, ii) Acetone, iii) Methanol, iv) Ethanol, v) 2-propanol, vi) THF, vii) DMF, viii) NMP, ix) DCM, x) DMSO, xi) Pyridine, xii) Diethyl ether, xiii) Toluene, xiv) Chloroform, xv) 1-Butanol, xvi) Cyclohexane, xvii) Hexene, xviii) 1,4-Dioxine, xix) Ethylene glycol, xx) Ethylene glycol Monomethyl Ether.

FIGS. 27A-B show the TGA profile for OL-CNOs with different joule heating times. FIG. 27A shows the TGA profile under Nitrogen, and FIG. 27B shows the TGA profile under air atmosphere.

FIGS. 28A-B show the tensile properties of PLA composite with different CNO. FIG. 28A shows the tensile strength of the composite, and FIG. 28B shows the tensile modulus of the composite.

FIGS. 29A-B show SEM images of the fracture surface of PLA (FIG. 29A) and PLA-CNOs with 0.5 wt % OL-CNO (FIG. 29B).

FIG. 30 shows the FTIR spectra of the composite.

FIG. 31 shows DSC thermograms of the PLA-CNOs.

FIGS. 32A-B show TGA (FIG. 32A) and DTG (FIG. 32B) profiles for PLA and PLA-CNOs with different loadings of OL-6 min.

FIG. 33 shows a schematic of the PLA-RO-CNO composite fabrication.

FIGS. 34A-34C show tensile properties of PLA-RO-CNO composites.

FIG. 34A shows tensile strength, FIG. 34B shows tensile modulus, and FIG. 34C shows elongation at break.

FIG. 35 shows impact strength of PLA-RO-CNO composites.

FIG. 36 shows heat distortion temperatures of PLA-RO-CNO composites.

FIGS. 37A-37J show SEM images of fractured surfaces of PLA (FIG. 37A), PLA-0.5CNO (FIG. 37B), PLA-10RO (FIG. 37C), PLA-10RO-0.5CNO (FIG. 37D), PLA-20RO (FIG. 37E), PLA-20RO-0.1CNO (FIG. 37F), PLA-20RO-0.5CNO (FIG. 37G), PLA-20RO-1CNO (FIG. 37H), PLA-30RO (FIG. 37I), and PLA-30RO-0.5CNO (FIG. 37J).

FIGS. 38A-38D show thermal properties of PLA-RO-CNO composites.

FIG. 38A shows TGA profiles of PLA and PLA-RO, FIG. 38B shows TGA profiles of PLA and CNO containing composites, FIG. 38C shows DTG profiles of PLA and PLA-RO, and FIG. 38D shows DTG profiles of PLA and CNO containing composites.

FIG. 39 shows modification of epoxy resin with CNO.

FIG. 40 shows glass fiber coated with CNO.

FIGS. 41A-41C show comparison of tensile properties of the composites.

FIG. 41A shows tensile strength, FIG. 41B shows tensile modulus, and FIG. 41C shows elongation at break.

### DETAILED DESCRIPTION

One aspect of the present application relates to a carbon nano-onion comprising a structure comprising a plurality of substantially concentric carbon shells. The substantially concentric carbon shells have a spherical, quasi-spherical, and/or polyhedral configuration or combinations thereof, wherein said substantially concentric carbon shells have surfaces functionalized with oxygen-containing functional groups.

In some embodiments, the substantially concentric carbon shells can have surfaces functionalized with any heteroatom-containing functional groups and/or metals. Functionalization of the surfaces can be modified according to the use intended for the carbon nano-onions.

In some embodiments, the substantially concentric carbon shells have surfaces functionalized with oxygen-containing functional groups and nitrogen-containing functional groups. In some embodiments, the substantially concentric carbon shells have surfaces functionalized with oxygen-containing functional groups and sulfur-containing functional groups.

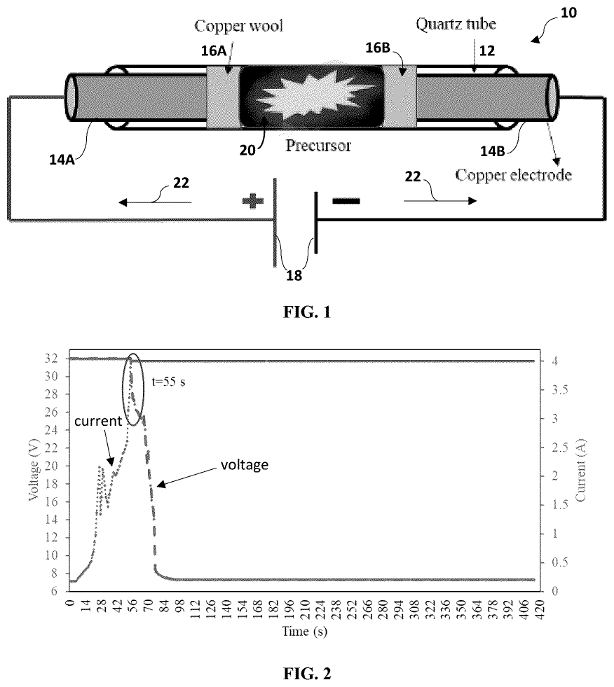

In some embodiments, the carbon nano-onion, or the carbon nano-onion structure of the present disclosure is prepared by joule heat treatment of a fixed carbon-containing source. Joule heating (also referred to as resistive, resistance, or Ohmic heating) is a process in which thermal energy is produced by passing current though an electrical conductor. An embodiment of a joule heating reactor of the present disclosure is illustrated in FIG. 1. As illustrated, joule heating reactor 10 includes quartz tube 12 with copper electrodes 14A and 14B covered with copper wool 16A and 16B at the two ends of the quartz tube. Each electrode 14A and 14B are connected to an adjustable power supply 18 (i.e., anode, positive electrode 14A connected to the positive terminal “+” of the power supply and cathode, negative electrode 14B connected to the negative terminal “−” of the power supply), and placed in contact with fixed carbon-containing source 20, which is loaded inside the quartz tube. Current 22 from power supply 18 enters the reactor through anode 14A and exits the reactor through cathode 14B.

The carbon nano-onion of the present disclosure can be prepared by joule heat treatment of any fixed carbon-containing source. In some embodiments, the fixed carbon-containing source is biomass.

The term “biomass,” as used herein, refers to renewable organic material that comes from plants and animals. In some embodiments of the carbon nano-onion, the biomass is lignin, biochar, any fixed carbon-containing biomass, or mixtures thereof. Suitable types of lignin include, without limitation, Hardwood Kraft Lignin (HKL), Softwood Kraft Lignin (SKL), Oragnosolv Hardwood Lignin, Oragnosolv Softwood Lignin, Herbaceous biomass-derived lignin, Acetosolv Lignin, Milled Wood Lignin (MWL), steam-explosion lignin, plasma-extraction lignin, chemically modified lignins, or combinations thereof.

The structure of the carbon nano-onions of the present disclosure can have concentric carbon shells, meaning the shells share a common center and larger shells surround smaller shells. When two or more shapes are perfectly concentric, the centers of the objects align exactly, and they share the same axis. In some embodiments, the structure of the carbon nano-onion of the present disclosure comprises substantially concentric shells, where the centers of the shells might be slightly offset, but the deviation is small enough that for the purposes of the design and function of the carbon nano-onion, the shells can be treated as if they are concentric. In some embodiments, exact alignment is not critical and slight deviations are expected. In some embodiments of the carbon nano-onion, each of the plurality of substantially concentric carbon shells are spaced about 0.3 nm to about 0.4 nm, or any amount or range therein, from its adjacent carbon shell. For example, in some embodiments each of the plurality of substantially concentric carbon shells are spaced about 0.31 nm to about 0.32 nm, about 0.31 nm to about 0.33 nm, 0.31 nm to about 0.34 nm, about 0.31 nm to about 0.35 nm, 0.31 nm to about 0.36 nm, about 0.31 nm to about 0.37 nm, about 0.31 nm to about 0.38 nm, about 0.31 nm to about 0.39 nm, about 0.33 nm to about 0.34 nm, about 0.33 nm to about 0.35 nm, 0.33 nm to about 0.36 nm, about 0.33 nm to about 0.37 nm, about 0.33 nm to about 0.38 nm, about 0.33 nm to about 0.39 nm, about 0.33 nm to about 0.4 nm, about 0.35 nm to about 0.36 nm, about 0.35 nm to about 0.37 nm, about 0.35 nm to about 0.38 nm, about 0.35 nm to about 0.39 nm, about 0.35 nm to about 0.4 nm, about 0.37 nm to about 0.38 nm, about 0.37 nm to about 0.39 nm, about 0.37 nm to about 0.4 nm, or about 0.39 nm to about 0.4 nm from its adjacent carbon shell. In some embodiments, the plurality of substantially concentric carbon shells are in the form of spherical graphitic layers. In some embodiments, the plurality of substantially concentric carbon shells are in the form of quasi-spherical graphitic layers. In some embodiments, the plurality of substantially concentric carbon shells are in the form of polyhedral graphitic layers. In some embodiments, the plurality of substantially concentric carbon shells comprise sp² hybridized carbons.

In some embodiments, the structure of the carbon nano-onion comprises a stack in a turbostratic form. The term “turbostratic,” as used herein, refers to a class of carbon having structural ordering in between that of amorphous carbon and that of crystalline graphite. Unlike in a pristine graphite structure, the carbon atoms in turbostratic carbon are not arranged in a regular, well-defined crystal lattice. Rather, the orientation of the carbon layers is more asymmetrical.

In some embodiments of the carbon nano-onion, the oxygen-containing functional groups comprise ethers, esters, carboxylic acids, ketones, aldehydes, or combinations thereof.

Another aspect of the present application relates to a composite material comprising the carbon non-onion disclosed herein and a polymer mixed with said carbon nano-onion.

In some embodiments, the polymer is a thermoplastic polymer. In some embodiments, the thermoplastic polymer comprises a plastic, polylactic acid, polyamide 6 (PA6), polyhydroxyalkanoates (PHAs), polyesters, polyethylene (PE), polypropylene (PP), polystyrene, polyvinyl chloride, or combinations thereof. Other thermoplastic polymers are known and can be used in the composite materials described herein.

In some embodiments, the polymer is a thermoset polymer. In some embodiments, the thermoset polymer comprises an epoxy resin, Triglycidyl p-amino-phenol, diglycidyl ester of hexahydrophthalic acid, epoxycresol novolak, epoxyphenol novolak, or combinations thereof. In some embodiments, the thermoset polymer comprises epoxy resin, and the epoxy resin is a bisphenol-A based epoxy. Other thermoset polymers are known and can be used in the composite materials described herein.

In some embodiments, the composite material further comprises a synthetic and/or natural fiber. An example of a suitable synthetic fiber is, without limitation, fiberglass. Suitable natural fibers include, without limitation, wood, agricultural plant fibers, or combinations thereof. In some embodiments, the wood is Red Oak.

In some embodiments, the composite material further comprises a curing agent. In some embodiments, the curing agent is a low viscosity curing agent 2120 Epoxy Hardener.

In some embodiments, the composite material contains 0.001 wt % to 10 wt % of the carbon nano-onion structure, or any amount or range therein. For example, in some embodiments the composite contains 0.001 wt % to 0.01 wt %, 0.001 wt % to 0.1 wt %, 0.001 wt % to 0.5 wt %, 0.001 wt % to 1 wt %, 0.001 wt % to 2 wt %, 0.001 wt % to 3 wt %, 0.001 wt % to 4 wt %, 0.001 wt % to 5 wt %, 0.001 wt % to 6 wt %, 0.001 wt % to 7 wt %, 0.001 wt % to 8 wt %, 0.001 wt % to 9 wt %, 0.001 wt % to 10 wt %, 0.01 wt % to 0.1 wt %, 0.01 wt % to 0.5 wt %, 0.01 wt % to 1 wt %, 0.01 wt % to 2 wt %, 0.01 wt % to 3 wt %, 0.01 wt % to 4 wt %, 0.01 wt % to 5 wt %, 0.01 wt % to 6 wt %, 0.01 wt % to 7 wt %, 0.01 wt % to 8 wt %, 0.01 wt % to 9 wt %, 0.01 wt % to 10 wt %, 0.1 wt % to 0.5 wt %, 0.1 wt % to 1 wt %, 0.1 wt % to 2 wt %, 0.1 wt % to 3 wt %, 0.1 wt % to 4 wt %, 0.1 wt % to 5 wt %, 0.1 wt % to 6 wt %, 0.1 wt % to 7 wt %, 0.1 wt % to 8 wt %, 0.1 wt % to 9 wt %, 0.1 wt % to 10 wt %, 0.5 wt % to 1 wt %, 0.5 wt % to 2 wt %, 0.5 wt % to 3 wt %, 0.5 wt % to 4 wt %, 0.5 wt % to 5 wt %, 0.5 wt % to 6 wt %, 0.5 wt % to 7 wt %, 0.5 wt % to 8 wt %, 0.5 wt % to 9 wt %, 0.5 wt % to 10 wt %, 1 wt % to 2 wt %, 1 wt % to 3 wt %, 1 wt % to 4 wt %, 1 wt % to 5 wt %, 1 wt % to 6 wt %, 1 wt % to 7 wt %, 1 wt % to 8 wt %, 1 wt % to 9 wt %, 1 wt % to 10 wt %, 2 wt % to 3 wt %, 2 wt % to 4 wt %, 2 wt % to 5 wt %, 2 wt % to 6 wt %, 2 wt % to 7 wt %, 2 wt % to 8 wt %, 2 wt % to 9 wt %, 2 wt % to 10 wt %, 3 wt % to 4 wt %, 3 wt % to 5 wt %, 3 wt % to 6 wt %, 3 wt % to 7 wt %, 3 wt % to 8 wt %, 3 wt % to 9 wt %, 3 wt % to 10 wt %, 4 wt % to 5 wt %, 4 wt % to 6 wt %, 4 wt % to 7 wt %, 4 wt % to 8 wt %, 4 wt % to 9 wt %, 4 wt % to 10 wt %, 5 wt % to 6 wt %, 5 wt % to 7 wt %, 5 wt % to 8 wt %, 5 wt % to 9 wt %, 5 wt % to 10 wt %, 6 wt % to 7 wt %, 6 wt % to 8 wt %, 6 wt % to 9 wt %, 6 wt % to 10 wt %, 7 wt % to 8 wt %, 7 wt % to 9 wt %, 7 wt % to 10 wt %, 8 wt % to 9 wt %, 8 wt % to 10 wt %, or 9 wt % to 10 wt % of the carbon nano-onion structure.

The carbon nano-onions described herein have the ability to improve the properties of polymers when the polymers are combined with the carbon nano-onions to form the composite materials described herein.

In some embodiments, the composite material has a higher tensile strength than that of the polymer without the carbon nano-onion structure. As used herein, “tensile strength” is defined as the maximum stress, measured as force per unit, that a material can bear before breaking when it is stretched or pulled.

In some embodiments, the composite material has a higher tensile modulus than that of the polymer without the carbon nano-onion structure. As used herein, “tensile modulus” refers to a mechanical property that measures a material's stiffness when subjected to tension or compression and is defined as the ratio of stress (force per unit area) to its strain (displacement or deformation) in the linear elasticity deformation region.

In some embodiments, the composite material has a higher flexural strength than that of the polymer without the carbon nano-onion structure. As used herein, “flexural strength,” also referred to as “bending strength,” is defined as a material's maximum stress before it yields to bending.

In some embodiments, the composite material has a higher flexural modulus than that of the polymer without the carbon nano-onion structure. As used herein, “flexural modulus,” also referred to as “bending modulus,” is the tendency for a material to resist bending, and is defined as the ratio of stress to strain in flexural deformation.

In some embodiments, the composite material has a higher impact strength than that of the polymer without the carbon nano-onion structure. As used herein, “impact strength” is defined as measure of a material's ability to resist cracking, fracturing, tearing, or damage under sudden application of force, and is expressed in terms of the amount of energy absorbed before fracture. The near-instantaneous implementation of load causes the material to absorb the energy, and when the amount of energy exceeds that which the material can accommodate, the material will experience fracture, cracking, tearing, or damage.

Polymers are permeable to gases and vapors to different extents. In some embodiments, the composite material has lower oxygen transmission and water vapor transmission than that of the polymer without the carbon nano-onion structure. As used herein, the oxygen transmission rate is defined as the rate at which oxygen gas permeates through a material over a given time. Water vapor transmission is the measure of the passage of water vapor through a material over a given time.

In some embodiments, the composite material has a higher thermal stability than that of the polymer without the carbon nano-onion structure. As used herein, “thermal stability,” is defined as the ability of a material to resist the action of heat energy by maintaining its mechanical properties, such as strength, toughness, or elasticity at a given temperature.

Another aspect of the present disclosure relates to a method of preparing an oxygen-functionalized carbon nano-onion. The method comprises providing a fixed carbon-containing source and treating the fixed carbon-containing source by joule heating under conditions effective to transform the fixed carbon-containing source into an oxygen-functionalized carbon nano-onion comprising a structure comprising a plurality of substantially concentric carbon shells, where the substantially concentric carbon shells have a spherical, quasi-spherical, and/or polyhedral configuration or combinations thereof.

In some embodiments of the method, the fixed carbon-containing source comprises biomass. In some embodiments the biomass is lignin, biochar, any fixed carbon-containing biomass, or mixtures thereof. Suitable types of lignin include, without limitation, Hardwood Kraft Lignin (HKL), Softwood Kraft Lignin (SKL), Oragnosolv Hardwood Lignin, Oragnosolv Softwood Lignin, herbaceous biomass-derived lignin, Acetosolv Lignin, Milled Wood Lignin, steam-explosion lignin, plasma-extraction lignin, chemically modified lignins, or combinations thereof. In some embodiments, when the biomass comprises lignin, the method further comprises subjecting the lignin to a carbonization process prior to said treating. In some embodiments, where the biomass comprises biochar, the method further comprises subjecting the biomass to pyrolysis to produce the biochar used in said treating.

In some embodiments of the method, said providing the fixed carbon-containing source comprises mixing the fixed carbon-containing source sample with 1 wt % to 10 wt % electrically conductive materials, or any amount or range therein, to form a mixture of fixed carbon-containing source and conductive materials, and subjecting the mixture of fixed carbon-containing source and conductive materials to grinding. For example, in some embodiments, the fixed carbon-containing source sample is mixed with 1 wt % to 2 wt %, 1 wt % to 3 wt %, 1 wt % to 4 wt %, 1 wt % to 5 wt %, 1 wt % to 6 wt %, 1 wt % to 7 wt %, 1 wt % to 8 wt %, 1 wt % to 9 wt %, 1 wt % to 10 wt %, 2 wt % to 3 wt %, 2 wt % to 4 wt %, 2 wt % to 5 wt %, 2 wt % to 6 wt %, 2 wt % to 7 wt %, 2 wt % to 8 wt %, 2 wt % to 9 wt %, 2 wt % to 10 wt %, 3 wt % to 4 wt %, 3 wt % to 5 wt %, 3 wt % to 6 wt %, 3 wt % to 7 wt %, 3 wt % to 8 wt %, 3 wt % to 9 wt %, 3 wt % to 10 wt %, 4 wt % to 5 wt %, 4 wt % to 6 wt %, 4 wt % to 7 wt %, 4 wt % to 8 wt %, 4 wt % to 9 wt %, 4 wt % to 10 wt %, 5 wt % to 6 wt %, 5 wt % to 7 wt %, 5 wt % to 8 wt %, 5 wt % to 9 wt %, 5 wt % to 10 wt %, 6 wt % to 7 wt %, 6 wt % to 8 wt %, 6 wt % to 9 wt %, 6 wt % to 10 wt %, 7 wt % to 8 wt %, 7 wt % to 9 wt %, 7 wt % to 10 wt %, 8 wt % to 9 wt %, 8 wt % to 10 wt %, or 9 wt % to 10 wt % conductive materials. In some embodiments, the conductive materials are carbon black, acetylene black, metal powder, carbon nano-onions, or combinations thereof.

In some embodiments of the method, the joule heating is carried out for 2 min to 10 min, or any amount or range therein. For example in some embodiments, the joule heating is carried out for 2 min to 3 min, 2 min to 4 min, 2 min to 5 min, 2 min to 6 min, 2 min to 7 min, 2 min to 8 min, 2 min to 9 min, 2 min to 10 min, 3 min to 4 min, 3 min to 5 min, 3 min to 6 min, 3 min to 7 min, 3 min to 8 min, 3 min to 9 min, 3 min to 10 min, 4 min to 5 min, 4 min to 6 min, 4 min to 7 min, 4 min to 8 min, 4 min to 9 min, 4 min to 10 min, 5 min to 6 min, 5 min to 7 min, 5 min to 8 min, 5 min to 9 min, 5 min to 10 min, 6 min to 7 min, 6 min to 8 min, 6 min to 9 min, 6 min to 10 min, 7 min to 8 min, 7 min to 9 min, 7 min to 10 min, 8 min to 9 min, 8 min to 10 min, or 9 min to 10 min.

In some embodiments of the method, the joule heating is carried out with DC electric source.

In some embodiments of the method, the joule heating is carried out with AC electric source.

In some embodiments of the method, the joule heating is carried out at a maximum voltage of 5 V to 10 kV, or any amount or range therein. For example, in some embodiments the joule heating is carried out at a maximum voltage of 5 to 100 V, 5 to 200 V, 5 to 300 V, 5 to 400 V, 5 to 500 V, 5 to 600 V, 5 to 700 V, 5 to 800 V, 5 to 900 V, 5 to 1000 V, 5 V to 5 kV, 50 to 100 V, 50 to 200 V, 50 to 300 V, 50 to 400 V, 50 to 500 V, 50 to 600 V, 50 to 700 V, 50 to 800 V, 50 to 900 V, 50 to 1000 V, 50 V to 5 kV, 50 V to 10 kV, 100 to 200 V, 100 to 300 V, 100 to 400 V, 100 to 500 V, 100 to 600 V, 100 to 700 V, 100 to 800 V, 100 to 900 V, 100 to 1000 V, 100 V to 5 kV, 100 V to 10 kV, 150 to 200 V, 150 to 300 V, 150 to 400 V, 150 to 500 V, 150 to 600 V, 150 to 700 V, 150 to 800 V, 150 to 900 V, 150 to 1000 V, 150 V to 5 kV, 150 V to 10 kV, 200 to 300 V, 200 to 400 V, 200 to 500 V, 200 to 600 V, 200 to 700 V, 200 to 800 V, 200 to 900 V, 200 to 1000 V, 200 V to 5 kV, 200 V to 10 kV, 250 to 300 V, 250 to 400 V, 250 to 500 V, 250 to 600 V, 250 to 700 V, 250 to 800 V, 250 to 900 V, 250 to 1000 V, 250 V to 5 kV, 250 V to 10 kV, 300 to 400 V, 300 to 500 V, 300 to 600 V, 300 to 700 V, 300 to 800 V, 300 to 900 V, 300 to 1000 V, 300 V to 5 kV, 300 V to 10 kV, 350 to 400 V, 350 to 500 V, 350 to 600 V, 350 to 700 V, 350 to 800 V, 350 to 900 V, 350 to 1000 V, 350 V to 5 kV, 350 V to 10 kV, 400 to 500 V, 400 to 600 V, 400 to 700 V, 400 to 800 V, 400 to 900 V, 400 to 1000 V, 400 V to 5 kV, 400 V to 10 kV, 450 to 500 V, 450 to 600 V, 450 to 700 V, 450 to 800 V, 450 to 900 V, 450 to 1000 V, 450 V to 5 kV, 450 V to 10 kV, 500 to 600 V, 500 to 700 V, 500 to 800 V, 500 to 900 V, 500 to 1000 V, 500 V to 5 kV, 500 V to 10 kV, 550 to 600 V, 550 to 700 V, 550 to 800 V, 550 to 900 V, 550 to 1000 V, 550 V to 5 V, 550 V to 10 kV, 600 to 700 V, 600 to 800 V, 600 to 900 V, 600 to 1000 V, 600 V to 5 kV, 600 V to 10 kV, 650 to 700 V, 650 to 800 V, 650 to 900 V, 650 to 1000 V, 650 V to 5 kV 650 V to 10 kV 700 to 800 V, 700 to 900 V, 700 to 1000 V, 700 V to 5 kV, 700 V to 10 kV, 750 to 800 V, 750 to 900 V, 750 to 1000 V, 750 V to 5 kV, 750 V to 10 kV, 800 to 900 V, 800 to 1000 V, 800 V to 5 kV, 800 V to 10 kV, 850 to 900 V, 850 to 1000 V, 850 V to 5 kV, 850 V to 10 kV, 900 to 1000 V, 900 V to 5 kV, 900 V to 10 kV, 950 to 1000 V, 950 V to 5 kV, 950 V to 10 kV, 1000 V to 5 kV, 1000 V to 10 kV, or 5 kV to 10 kV. The maximum voltage can be more or less depending on the scale in which the method is carried out.

In some embodiments of the method, the joule heating is carried out at a maximum current of 0.1 to 1000 A, or any amount or range therein. For example, in some embodiments the joule heating is carried out a maximum current of 0.1 to 10 A, 0.1 to 20 A, 0.1 to 30 A, 0.1 to 40 A, 0.1 to 50 A, 0.1 to 60 A, 0.1 to 70 A, 0.1 to 80 A, 0.1 to 90 A, 0.1 to 100 A, 0.1 to 500 A, 0.1 to 1000 A, 0.5 to 10 A, 0.5 to 20 A, 0.5 to 30 A, 0.5 to 40 A, 0.5 to 50 A, 0.5 to 60 A, 0.5 to 70 A, 0.5 to 80 A, 0.5 to 90 A, 0.5 to 100 A, 0.5 to 500 A, 0.5 to 1000 A, 1 to 10 A, 1 to 20 A, 1 to 30 A, 1 to 40 A, 1 to 50 A, 1 to 60 A, 1 to 70 A, 1 to 80 A, 1 to 90 A, 1 to 100 A, 1 to 500 A, 1 to 1000 A, 10 to 20 A, 10 to 30 A, 10 to 40 A, 10 to 50 A, 10 to 60 A, 10 to 70 A, 10 to 80 A, 10 to 90 A, 10 to 100 A, 10 to 500 A, 10 to 1000 A, 15 to 20 A, 15 to 30 A, 15 to 40 A, 15 to 50 A, 15 to 60 A, 15 to 70 A, 15 to 80 A, 15 to 90 A, 15 to 100 A, 15 to 500 A, 15 to 1000 A, 20 to 30 A, 20 to 40 A, 20 to 50 A, 20 to 60 A, 20 to 70 A, 20 to 80 A, 20 to 90 A, 20 to 100 A, 20 to 500 A, 20 to 1000 A, 25 to 30 A, 25 to 40 A, 25 to 50 A, 25 to 60 A, 25 to 70 A, 25 to 80 A, 25 to 90 A, 25 to 100 A, 25 to 500 A, 25 to 1000 A, 30 to 40 A, 30 to 50 A, 30 to 60 A, 30 to 70 A, 30 to 80 A, 30 to 90 A, 30 to 100 A, 30 to 500 A, 30 to 1000 A, 35 to 40 A, 35 to 50 A, 35 to 60 A, 35 to 70 A, 35 to 80 A, 35 to 90 A, 35 to 100 A, 35 to 500 A, 35 to 1000 A, 40 to 50 A, 40 to 60 A, 40 to 70 A, 40 to 80 A, 40 to 90 A, 40 to 100 A, 40 to 500 A, 40 to 1000 A, 45 to 60 A, 45 to 70 A, 45 to 80 A, 45 to 90 A, 45 to 100 A, 45 to 500 A, 45 to 1000 A, 50 to 60 A, 50 to 70 A, 50 to 80 A, 50 to 90 A, 50 to 100 A, 50 to 500 A, 50 to 1000 A, 55 to 60 A, 55 to 70 A, 55 to 80 A, 55 to 90 A, 55 to 100 A, 55 to 500 A, 55 to 1000 A, 60 to 70 A, 60 to 80 A, 60 to 90 A, 60 to 100 A, 60 to 500 A, 60 to 1000 A, 65 to 70 A, 65 to 80 A, 65 to 90 A, 65 to 100 A, 65 to 500 A, 65 to 1000 A, 70 to 80 A, 70 to 90 A, 70 to 100 A, 70 to 500 A, 70 to 1000 A, 75 to 80 A, 75 to 90 A, 75 to 100 A, 75 to 500 A, 75 to 1000 A, 80 to 90 A, 80 to 100 A, 80 to 500 A, 80 to 1000 A, 85 to 90 A, 85 to 100 A, 85 to 500 A, 85 to 1000 A, 90 to 100 A, 90 to 500 A, 90 to 1000 A, 100 to 500 A, 100 to 1000 A, 200 to 500 A, 200 to 1000 A, 300 to 500 A, 300 to 1000 A, 400 to 500 A, 400 to 1000 A, 500 to 1000 A, 600 to 1000 A, 700 to 1000 A, 800 to 1000 A, or 900 to 1000 A.

Another aspect of the present application relates to a method of preparing a composite material. This method involves providing the carbon nano-onion disclosed herein, blending a polymer with the carbon nano-onion to form a mixture, and forming a composite material from the mixture. In some embodiments of the method, polylactic acid (PLA) is fabricated with carbon nano-onion additives by dispersing the carbon nano-onions in 100 mL dichloromethane (DCM), stirring with a magnetic stir bar, and then subsequently adding PLA to the carbon nano-onion and DCM mixture.

In carrying out the method of preparing a composite material, the resulting composite material can have the various characteristics described herein, including those described above.

In some embodiments of the method, said providing is carried out by dispersing the carbon nano-onion in a solvent and said forming comprises removing the solvent from the mixture. Suitable solvents include, without limitation, DI water, acetone, methanol, ethanol, 2-propanol, tetrahydrofuran (THF), N, N-dimethylformamide (DMF), N-methyl-2-pyrrolidone (NMP), dichloromethane (DCM), dimethyl sulfoxide (DMSO), pyridine, diethyl ether, toluene, chloroform, 1-butanol, cyclohexane, hexene, 1, 4-dioxine, ethylene glycol, or ethylene glycol monomethyl ether.

In some embodiments, the method is carried out in a heated extruder. An extruder is a motor-driven screw inside a tube or barrel. Various raw materials can be fed into the extruder, while a hot fluid can be circulated through a hollow jacket around the outside of the barrel in order to melt the material inside the barrel.

In some embodiments of the method, said forming is carried out by injection molding. Injection molding is a manufacturing process for producing parts by injecting molten material into a mold. Material, such as thermoplastic or thermosetting polymers, is fed into a heated barrel, mixed, and injected into a mold cavity, where it cools and hardens to the configuration of the cavity.

In some embodiments, said forming is carried out in a hot press. Hot pressing is a manufacturing process that involves the application of heat and pressure to a material to create a dense and uniform product. Material is placed in a mold and then heated to high temperature while applying pressure, which causes the material to soften and flow, filling the mold to create a dense and uniform product.

In some embodiments, said forming is carried out by a film casting process. Film casting is a process for producing thin films that involves dissolving a polymer in a volatile solvent which is subsequently evaporated.

In some embodiments of the method, the polymer is a thermoplastic polymer. In some embodiments the thermoplastic polymer comprises plastics, polylactic acid, polyamide 6 (PA6), polyhydroxyalkanoates (PHAs), polyesters, polyethylene (PE), polypropylene (PP), polystyrene, polyvinyl chloride, or combinations thereof. Other thermoplastic polymers are known and can be used.

In some embodiments of the method, the polymer is a thermoset polymer. In some embodiments, the thermoset polymer comprises an epoxy resin, Triglycidyl p-amino-phenol, diglycidyl ester of hexahydrophthalic acid, epoxycresol novolak, epoxyphenol novolak, and combinations thereof. In some embodiments, the thermoset polymer comprises epoxy resin, and the epoxy resin is a bisphenol-A based epoxy. Other thermoset polymers are known and can be used.

In some embodiments, the method further comprises blending a natural fiber or a synthetic fiber with the polymer and the carbon nano-onion. An example of a suitable synthetic fiber is, without limitation, fiberglass. Suitable natural fibers include, without limitation, wood, agricultural plant fibers, or combinations thereof. In some embodiments, the wood is Red Oak.

In some embodiments, when the polymer is a thermoset polymer, the forming step can further comprise adding a curing agent. In some embodiments, the curing agent is a low viscosity curing agent 2120 Epoxy Hardener. In some embodiments, said forming step can further comprise coating a glass fiber with the mixture.

The above disclosure is general. A more specific description is provided below in the following examples. The examples are described solely for the purpose of illustration and are not intended to limit the scope of the present application. Changes in the form and substitution of equivalents are contemplated as circumstances suggest or render expedient. Although specific terms have been employed herein, such terms are intended in a descriptive sense and not for the purposes of limitation.

### EXAMPLES

The following examples are provided to illustrate embodiments of the present application but are by no means intended to limit scope.

### Example 1—Carbon Nano-onion Synthesis and Fabrication of Polylactic Acid (PLA) with CNO Additives

### Materials and Methods

### Materials

Organosolv lignin (OL) and Kraft lignin (KL) are provided by industrial sources. Biochar (BC) was a co-product during fast pyrolysis of pinewood at 500° C., produced in the Biocentury Research Farm of Iowa State University. Carbon black was purchased from Chemical Store, Inc. PLA (Ingeo 2500HP) was purchased from NatureWorks. Graphene nanoplatelets (GNPs) (2-10 nm thickness) was procured from ACS Materials, LLC. OL and KL were washed in deionized water at 90° C. for 4 hrs under continuous stirring at 300 rpm. The washed OL and KL were dried overnight in a vacuum oven and stored. All solvents were procured from Fisher Chemicals.

### CNO Synthesis

Before joule heating, lignins were degassed by heating under an inert environment from room temperature to 500° C. at 10° C./min and 500° C. to 700° C. at 8° C./min. The carbonized lignins were milled for 3 min. During the joule heating process, about 0.8 g of pre-carbonized lignin mixed with 5% carbon black were tightly packed inside a quartz-tube reactor and in contact with copper electrodes covered with copper wool at the two ends. The same amount of milled biochar was mixed with 8% carbon black when biochar is the precursor. Carbon black was added to improve the electric conductivity of the starting materials. In the reactor, the electrodes were connected to a Hanmatek HM 305 adjustable DC power supply unit with a maximum voltage and current set at 32 V and 4 A. A schematic illustration of a possible reactor setup is given in FIG. 1.

FIG. 2 shows the relationship between voltage and current as a function of time. Initially, the voltage remained at 32V and the current increased with time. When the current reached a set maximum current (4 A), the voltage dropped to 6.8V for precarbonized OL and precarbonized KL and 7.2V for BC. Afterwards, the voltage and current both remained unchanged for the rest of the process. The joule heating time was counted when the current reached the maximum and the voltage dropped.

Fabrication of Polylactic Acid (PLA) with CNO Additives

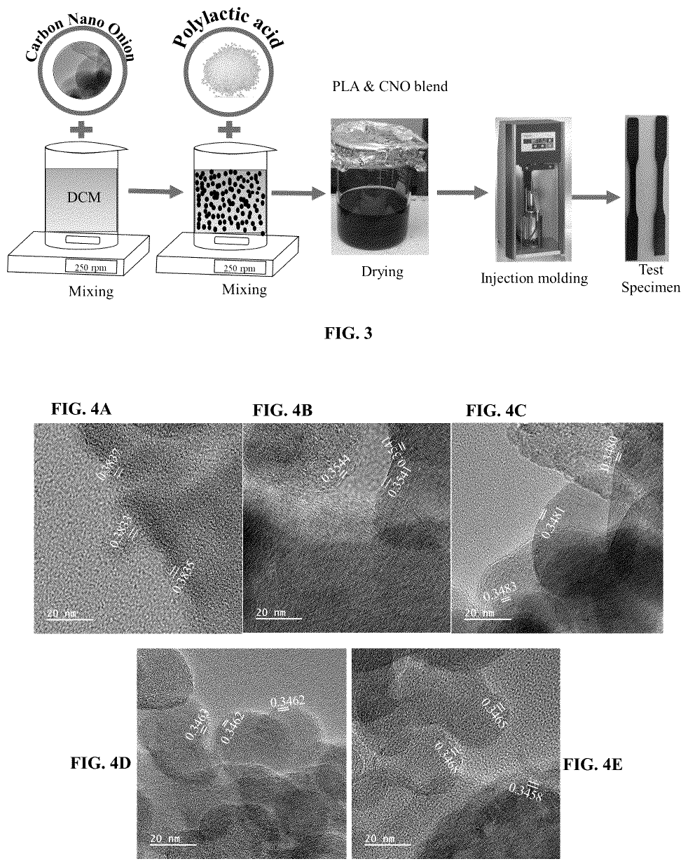

A solution mixing followed by an injection molding method was used to prepare PLA composites with CNO additives. CNOs were first dispersed into 100 mL of dichloromethane (DCM) and stirred using a magnetic stir bar for 1.5 hrs. PLA was subsequently added to the CNO and DCM mixture and stirred for an additional 2.5 hrs. The mixture was then dried in a vacuum oven to remove the solvent. The dried PLA-CNO was processed using Haake Minijet injection molder (Thermo Scientific). A schematic illustration of a possible fabrication process is given in FIG. 3. Additionally, a PLA composite containing GNP was prepared using the same method.

### Characterizations

### High Resolution Transmission Electron Microscope (HRTEM)

HRTEM analysis was conducted using a JEOL 2100 scanning TEM (Japan Electron Optics Laboratories) with a Gatan OneView 4K camera (Gatan, Inc.) and an operating voltage of 200 kV. Samples were prepared by drop casting of 10 μL ethanol with CNOs in a 200 mesh copper grid. Image J software was used to analyze the TEM images. The average interlayer spacing (d₀₀₂) and nanoparticles diameter were calculated from the corresponding output of the image processing.

### X-Ray Diffraction (XRD)

XRD was performed using Siemens D500 diffractometer with Cu Kα radiation (λ=1.5432 Å). The step time was 2 s and a Bragg angle range was 100-50°.

The interlayer spacing d₀₀₂(nm) was evaluated based on the (002) peak position from Bragg's law:

$${d}_{002} = \frac{λ}{2 sin θ}$$

where λ is the wavelength (nm), θ is the Bragg angle for the corresponding (002) peak.

Crystallite thickness (L_{c}) and crystallite lateral size (Lₐ) were determined using (002) and (100) peaks using Scherrer's formula:

$${L}_{c / a} = \frac{K λ}{B cos θ}$$

where B and θ associated with the full width at half maxima (FWHM) and the Bragg angle, respectively; K=0.89 and 1.84 for (002) and (100) peaks, respectively. Gaussian peak fitting was used to determine (0 0 2) and (1 0 0) peak locations.

Aromaticity (fₐ) evaluated by deconvoluting 2θ from 15 to 30° over two pseudo-Voigt peaks at roughly 20° for γ peak and around 26° for (002) for peak applying the following formula:

$${f}_{a} = \frac{{A}_{002}}{{A}_{002} + {A}_{γ}}$$

where A₀₀₂ and A_{γ} are the peak areas for (002) and γ peaks, respectively.

### Raman Analysis

Raman spectroscopy was performed using DXR Raman Microscope (Thermo Fisher, Waltham, MA) and a 532 nm laser with a power of 5 mW to determine the degree of graphitization. A 50× lens was used for local Raman spectra. The spectra were deconvoluted into four peaks (D, G, D+D″, and 2D) by Gaussian peak fitting. The band intensities, including the intensity ratio (I_{D}/I_{G}) and area ratio i.e. peak integrated area ratio (A_{D}/A_{G}) of the D to G peak, were calculated. I_{2D}/I_{G} ratio was also calculated from the intensity of 2D and G peaks to determine the graphitic layers.

### X-Ray Photoelectron Spectrometry (XPS)

Surface functional groups were identified using XPS (Kratos Amicus X-ray Photoelectron Spectrometer). All survey and elemental scans were performed using 1 eV and 0.1 eV steps, respectively, with a pass energy of 150 eV. The C1 peak level spectra at 284.6 eV was used to correct the change in the binding energy brought on by the sample's surface charge-up.

### Solvent Dispersibility

Dispersion of CNOs was performed in the following 20 solvents: DI water, acetone, methanol, ethanol, 2-propanol, tetrahydrofuran (THF), N, N-dimethylformamide (DMF), N-methyl-2-pyrrolidone (NMP), dichloromethane (DCM), dimethyl sulfoxide (DMSO), pyridine, diethyl ether, toluene, chloroform, 1-butanol, cclohexane, hexene, 1, 4-dioxine, ethylene glycol, and ethylene glycol monomethyl ether. Two milligrams of the sample was dispersed into a 20 mL solvent and sonicated for an hour. The sonicated solution was centrifuged at 1000 rpm for an additional hour.

### Fourier Transform Infrared Spectroscopy (FTIR)

FTIR was performed using a Thermo Scientific Nicolet iS10 equipped with a Smart iTR accessory in a range of 500-4000 cm⁻¹ and scanned 64 times with 4 cm⁻¹ resolution.

### Thermal Stability and Proximate Analysis

Thermal analyses were determined by using a TGA-DSC STARe system, Metler Toledo. Thermal stability of CNO was evaluated by heating 30 mg of CNO from room temperature to 900° C. at 10° C./min using either nitrogen or air with a flow rate of 100 mL/min. Ash content in CNO was determined by performing proximate analysis using the following procedure: heating about 30 mg of CNO using 100 mL/min nitrogen from room temperature to 120° C. at 10° C./min and keeping for 5 mins, from 120° C. to 900° C. at 10° C./min and holding at the final temperature for 30 min, and finally introducing air at 900° C. to combust the residues. The experiments were duplicated to report average results. For thermal stability analysis of PLA composite, about 30 mg of PLA composite containing CNO (PLA-CNO) were heated from room temperature to 700° C. at 10° C./min in the presence of nitrogen.

### Electrical Conductivity

Electric conductivity of CNOs can be measured based on the following equations.

$$R = \frac{U}{I}$$

where R is the electrical resistance (Ω), U is the stabilized voltage (V), and I is the stabilized electrical current (A) during the joule heating.

$$ρ = R \frac{A}{L}$$

where ρ is the electrical resistivity (Ω·m), L is the length of the sample between the two electrodes, A is the inner cross-sectional area of the reactor.

$$σ = \frac{1}{ρ}$$

where σ is the electrical conductivity (S/m).

### Mechanical Properties

An Instron 5944 tensile tester was used to test the tensile properties of PLA-CNOs at 10 mm/min according to the ASTM D638 method. The 3-point bending test was conducted in the Instron 5944 tensile tester using the ASTM D7264 method. A Tinius Olsen Impact tester was used to perform the impact strength. ASTM D256 specifications were used to create notches in the impact bar. At least five specimens were tested for each test.

### SEM Analysis

The scanning electron microscope (SEM, Quanta-FEG 250, FEI) was used to observe the morphology of polymer or polymer composites at their tensile bar fracture surfaces.

### Differential Scanning Calorimetry (DSC) Analysis

The thermal behavior of PLA/CNO composite was determined by differential scanning calorimetry (DSC, Q2000, TA instruments) under nitrogen atmosphere. Approximately 10 mg of composite sample was used for the measurement under the following protocol: firstly, the sample was heated from 25° C. to 220° C. at 20° C./min and kept at 220° C. for 5 min to eliminate thermal history. Secondly, the sample was cooled down to −50° C. to detect the cold crystallization temperature (T_{cc}). Finally, the samples were heated again to 220° C. at 20° C./min to determine the melting temperature (Tₘ).

### Oxygen and Water Barrier Properties

ASTM D3985 standards were used to determine the oxygen transmission rate (OTR) in an oxygen permeation testing analyzer (MOCON's OX-TRAN model 2/21) under a carrier gas mixture of 98% nitrogen, 2% hydrogen, and a test gas of 99.9% oxygen. A water vapor transmission (WVTR) test was performed in a Permatran-W (MOCON) under a nitrogen carrier gas and water vapor as the test gas. Test specimens (0.5 mm thickness and 25 mm dia.) were prepared using injection molding with a cylinder temperature of 240° C. and mold temperature of 90° C. The oxygen transmission and water vapor transmission were collected every 30 min and stopped once the steady state condition of oxygen and water vapor concentration was reached.

### Results and Discussion

### Characterization of Biobased CNO

### TEM Results

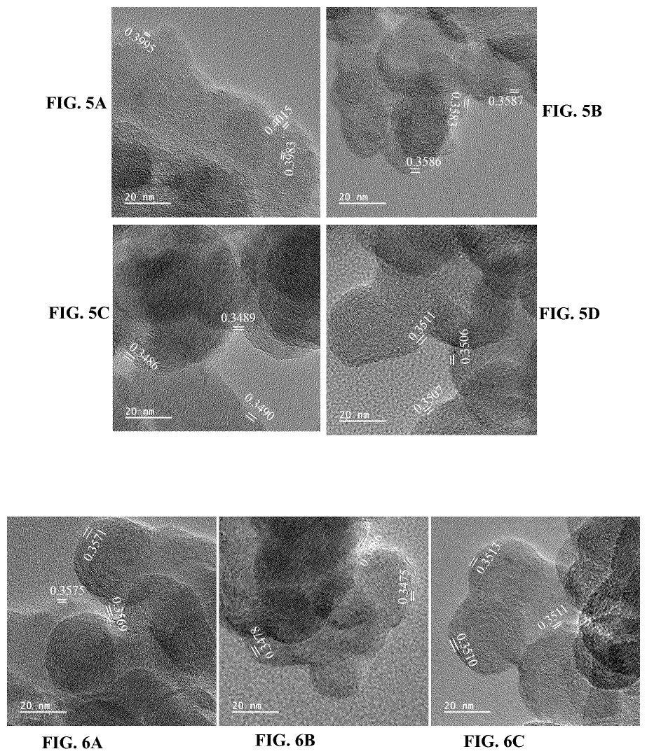

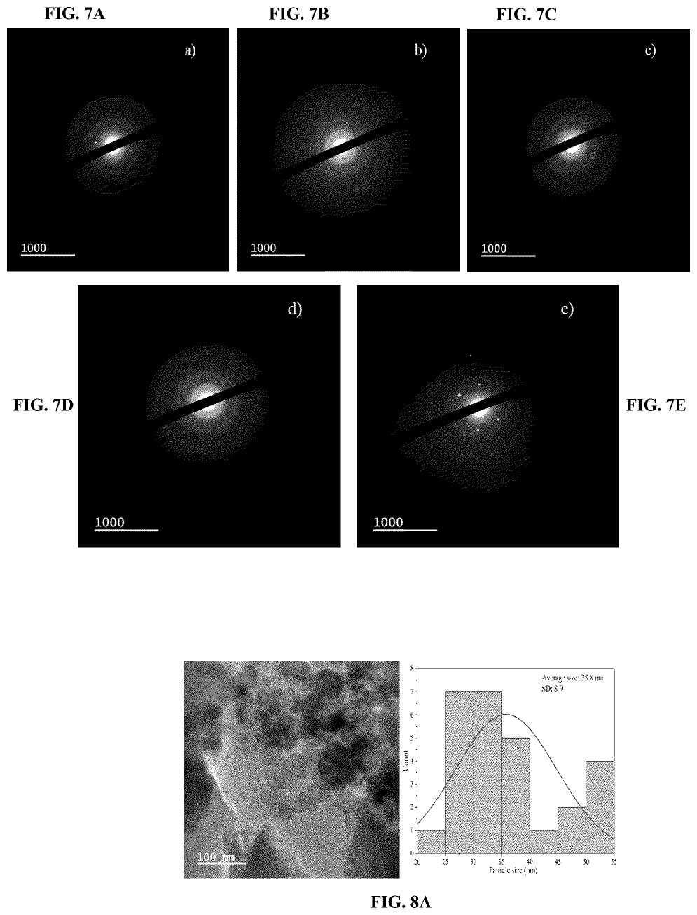

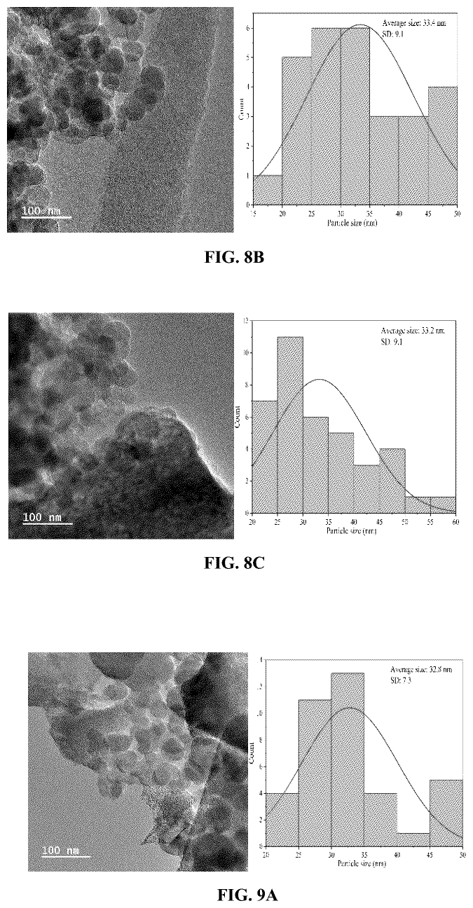

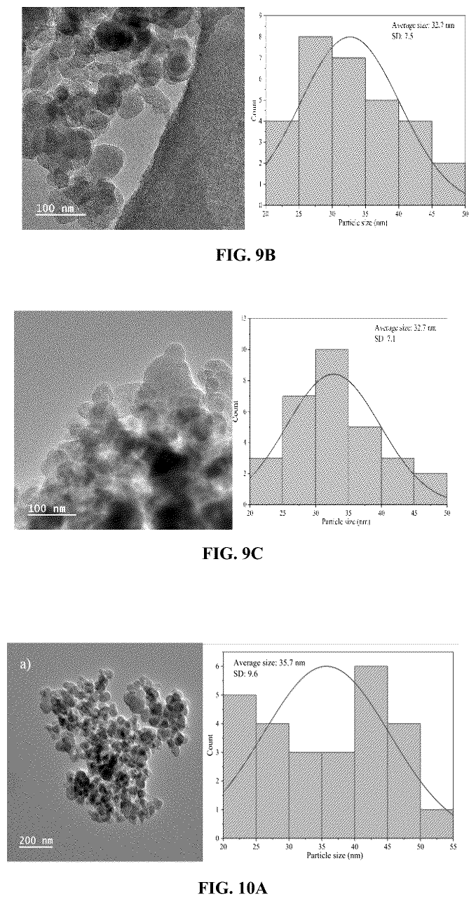

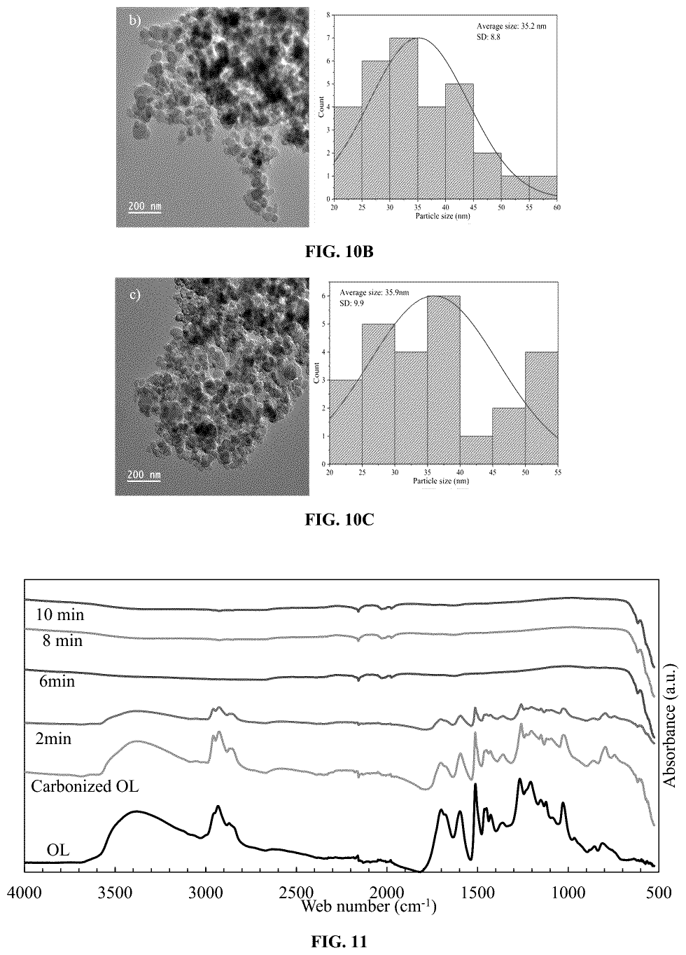

FIGS. 4A-4E, 5A-5D, and 6A-6C show the representative TEM micrographs of the lignins and BC-derived samples with different joule heating treatment conditions. The precarbonized OL without joule heating showed amorphous carbon structures (FIG. 4A), which is common for carbonizing lignin due to lack of orientable molecular structures and difficult to form graphitic carbons. At the initial stage of the joule heating, nanocrystalline formation and aggregation of small nanocrystallite filaments were observed with 2 min sample (FIG. 4B). As the treatment time increased, nanoparticles with quasi-spherical morphology can be seen in the samples treated for 6, 8, and 10 min (FIGS. 4C-4E). The transition from amorphous structure to quasi-spherical nanoparticles was also observed with KL and biochar-derived CNOs (FIGS. 5A-5D and 6A-6C). The TEM images confirm the onion-like morphology of CNOs where highly crystallized graphene shells clearly exhibited lattice fringes corresponding to the interlayer (002) plane. The selected area electron diffraction (SAED) patterns (FIGS. 7A-7E for OL-CNO) display a set of rings that match the reflection from two crystal planes (002) and (100), supporting the graphitic phase in CNO. The time-dependent TEM results also show that the nanocrystalline formation was followed by their aggregation and merging during the joule heating to form spherical, organized, multi-centered concentric CNO. As the disordered carbons continued incorporating into spherical CNO, centered around a single core, the number of multi-centers decreased with longer treatment times. The TEM-measured interlayer spacing (d₀₀₂) of CNO ranged from 0.3462 nm to 0.3585 nm for various CNO obtained using different precursors and treatment times, narrower than that of the non-CNO samples (Table 1). It was also found that the particle size of the CNO was less affected by the precursor type and treatment time, reporting average particle sizes to be 33-36 nm (particle distribution of OL, KL, and BC-based CNOs in FIGS. 8A-8C for OL, FIGS. 9A-9C for KL, and FIGS. 10A-10C for BC). Noteworthy, the morphology and structures of the nanocarbon obtained in this work are distinctively different from those reported by Luong et al. (Luong et al., “Gram-scale bottom-up flash graphene synthesis,” Nature, 577(7792):647-651 (2020), which is hereby incorporated by reference in its entirety). In Luong's work, a high electric field was applied for an extremely short duration to generate extremely high heating rates, converting organic materials to a few-layered graphene. In Applicant's work, a much milder electric field was applied to generate steady joule heating at a controllable time scale, causing the newly formed graphene carbons to further aggregate into a quasi-sphere CNO structure.

### FTIR Results

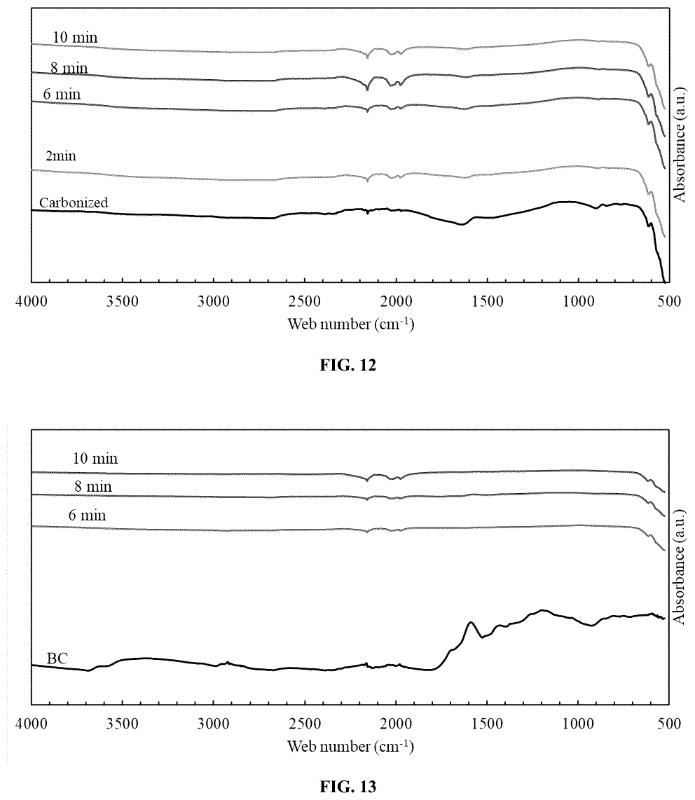

FIG. 11 shows the FTIR spectra for untreated and treated OL. Precarbonized lignin before joule heating contained considerable amounts of the original lignin functional groups, such as OH (3200-3600 cm⁻¹), CH₂/CH₃ (2800-2945 cm⁻¹), carbonyls (1650-1720 cm⁻¹), aromatic ring vibration (1500 cm⁻¹), etc. These IR signals of functional groups were still observed with the sample with a 2 min treatment time, but nearly disappeared with the CNOs produced using higher treatment times. The results suggest the intensive chain cleavages and carbonization of lignin during joule heating process, which is needed to form CNOs with graphitic layer structure. FTIR spectra for KL and BC based CNOs are presented in FIGS. 12 and 13, respectively, and show a similar trend to OL-CNOs.

### XRD Results

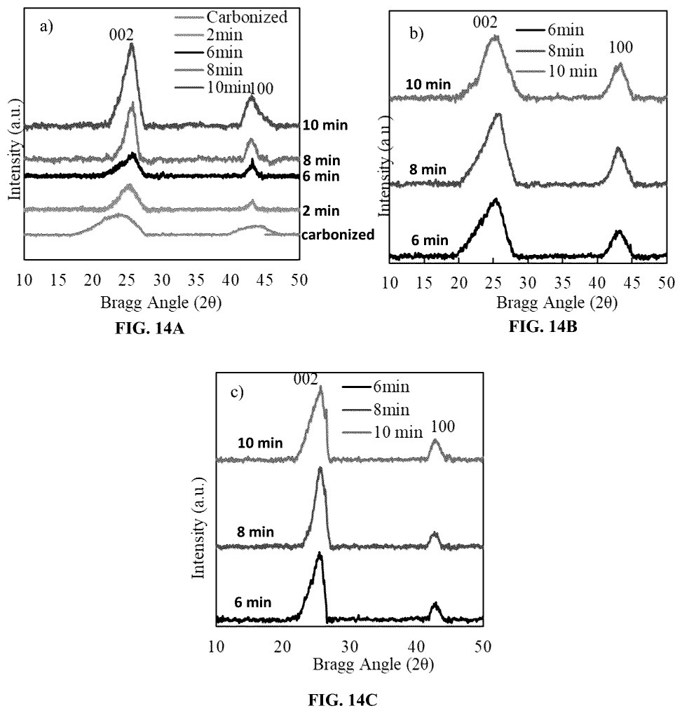

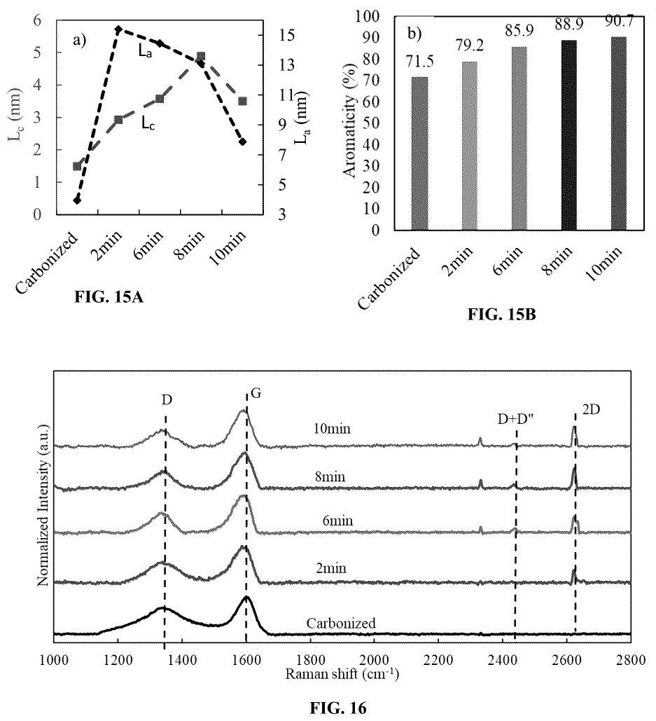

FIGS. 14A-14C show the XRD results for different CNOs. Diffraction peaks appearing around ˜25° and ˜43° are attributed to (002) and (100) plane reflection of the CNO crystallites (Mohapatra et al., “Enzymatic and Non-enzymatic Electrochemical Glucose Sensor Based on Carbon Nano-onions,” Appl. Surf Sci. 442:332-341 (2018); Liu et al., “Functionalization of Carbon Nano-onions by Direct Fluorination,” Chem. Mater. 19(4):778-786 (2007); which are hereby incorporated by reference in their entirey). In general, (002) peak position shifted to the right side for the treated samples compared to the precarbonized OL (˜23°), (the Bragg angles included in Table 1) suggesting the formation of an ordered graphitic crystalline structure (Garcia-Negron et al., “Processing-Structure-Property Relationships for Lignin-Based Carbonaceous Materials Used in Energy-Storage Applications,” Energy Technology, 5(8):1311-1321 (2017); Garcia-Negron et al., “Development of Nanocrystalline Graphite from Lignin Sources,” ACS Sustainable Chem. Eng., 10(5):1786-1794 (2022); which are hereby incorporated by reference in their entirety). Table 1 compares the structural parameters determined based on XRD, Raman and TEM for all CNOs. In FIG. 14A, the carbonized lignin and the 2 min-treated sample had broader (0 0 2) peaks because of their amorphous carbons and poor crystallinity compared to the CNO samples. The (002) peak became narrower for the CNOs, which is indicative of the increased graphitization. For OL-derived samples, the d₀₀₂ values decreased from 0.3803 nm with the carbonized OL to 0.3468 nm with the 8 min-treated CNO and slightly increased to 0.3471 nm for the 10 min-treated CNO. While the XRD results agree with the TEM-based measurement described earlier in Table 1, the d₀₀₂ values of CNO were greater than the interlayer spacing of the conventional Bernal (AB-stacked) graphite (0.337 nm) (Luong et al., “Gram-Scale Bottom-Up Flash Graphene Synthesis,” Nature, 577:647-651 (2020), which is hereby incorporated by reference in its entirety), suggesting that the structure of CNOs is stacked in a turbostratic form. The (0 0 2) peak is asymmetric with a tail at smaller angles, supporting the turbostratic structure. However, peak width almost remained the same for CNO samples with different treatment times, suggesting the lattice's growth from in-plane hexagonal networks to the curved CNO (Guo et al., “Soft-Chemistry Synthesis, Solubility and Interlayer Spacing of Carbon Nano-Onions,” RSC Advances, 11:6850-6858 (2021), which is hereby incorporated by reference in its entirety). The crystalline dimension of OL-CNO is also compared. The Lₑ value (FIG. 15A) increased with increasing treatment time up to 8 min and decreased at 10 min. On the other hand, Lₐ (FIG. 15A) increased in the 2 min-treated sample and started to decrease as the CNO formed. The breakdown of precursor side chains, increased aromatization, and the formation of spherical structures were the primary causes of the decrease in Lₐ (A. O. Odeh, “Comparative Study of the Aromaticity of the Coal Structure During the Char Formation Process Under Both Conventional and Advanced Analytical Techniques,” Energy and Fuels 29(4):2676-2684 (2015), which is hereby incorporated by reference in its entirety). The structural parameters, including those of KL and BC-based CNOs, are included in Table 1. The XRD data for KL and BC-based CNO also showed a similar pattern of structural parameter change along with the increasing treatment time as it was observed with OL-based CNO. On the other hand, the aromaticity (FIG. 15B) of the CNO increased with the increased treatment time. Aromaticity reversely correlates to the proportion of carbon atoms in the edge of aliphatic side chains to aromatic rings. Thus, the increased aromaticity confirms the decomposition of precursor side chains and the formation of the aromatic ring structure in spherical graphitic CNO.

TABLE 1
Summary of structural parameters of different carbon
samples based on TEM, XRD, and Raman results

| | TEM | XRD | | | | | | |
|---|---|---|---|---|---|---|---|---|
| Sample | d₀₀₂ | d₀₀₂ | Bragg | L_{c} | Lₐ | Raman | | |
| condition | (nm) | (nm) | Angle (2θ) | (nm) | (nm) | A_{D}/A_{G} | I_{D}/I_{G} | I_{2D}/I_{G} |
| Carbonized OL | 0.3835 | 0.3803 | 23.41 | 1.49 | 3.96 | 1.94 | 0.70 | — |
| OL-2 min | 0.3542 | 0.3547 | 25.13 | 2.93 | 15.40 | 0.94 | 0.57 | 0.30 |
| OL-6 min | 0.3481 | 0.3472 | 25.68 | 3.57 | 14.45 | 0.6 | 0.52 | 0.42 |
| OL-8 min | 0.3462 | 0.3468 | 25.71 | 4.89 | 13.10 | 0.57 | 0.48 | 0.56 |
| OL-10 min | 0.3463 | 0.3471 | 25.69 | 3.50 | 7.88 | 0.56 | 0.48 | 0.59 |
| KL-6 min | 0.3585 | 0.3540 | 25.18 | 2.49 | 7.95 | 0.67 | 0.51 | 0.45 |
| KL-8 min | 0.3488 | 0.3484 | 25.59 | 2.55 | 7.91 | 0.51 | 0.48 | 0.49 |
| KL-10 min | 0.3508 | 0.3511 | 25.39 | 2.30 | 7.88 | 0.46 | 0.47 | 0.50 |
| BC-6 min | 0.3572 | 0.3545 | 25.14 | 3.62 | 12.39 | 0.77 | 0.72 | 0.46 |
| BC-8 min | 0.3480 | 0.3488 | 25.56 | 4.39 | 12.31 | 0.62 | 0.53 | 0.66 |
| BC-10 min | 0.3511 | 0.3519 | 25.33 | 3.29 | 10.89 | 0.57 | 0.51 | 0.68 |

### Raman Results

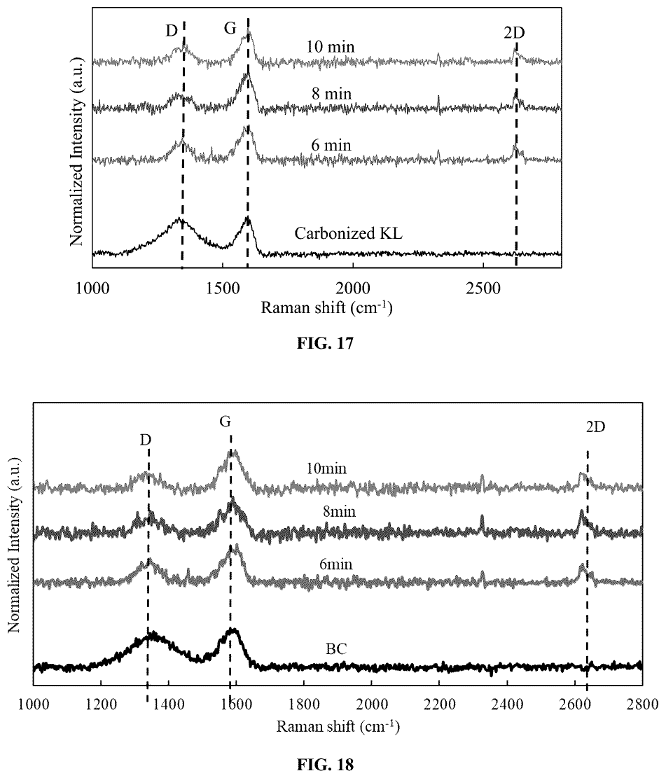

Raman spectra of the OL-CNOs are given in FIG. 16 (FIG. 17 for KL-CNO and FIG. 18 for BC-CNOs). Three prominent “finger-print” peaks can be observed centered around 1326-1346 cm⁻¹, 1583-1589 cm⁻¹, and 2622-2627 cm⁻¹ corresponding to D, G, and 2D bands (Jänes et al., “Characterisation of Activated Nanoporous Carbon for Supercapacitor Electrode Materials,” Carbon N. Y. 45(6):1226-1233 (2007), which is hereby incorporated by reference in its entirety). The one-phonon Raman scattering process, which is sensitive to defects and surface change, is responsible for forming the D-band. The D-band intensity is attributed to the disorder brought by C—C vibrations that correspond to the dissolution of the sp³ hybridized carbon bonds, as well as the presence of dangling bonds, C and H atoms, intercalated C and H atoms, vacancies, and other carbon rings resulting from structural rearrangement and/or reordering (Roy et al., “Characterisation of Carbon Nano-onions Using Raman Spectroscopy,” Chem. Phys. Lett. 373(1-2):52-56 (2003), which is hereby incorporated by reference in its entirety). The G-band, which occurs in the absence of defects, is the stretching vibration of sp²-linked carbon atoms in the plane formed through the one-phonon Raman scattering mechanism, and it shows the order of graphitic carbons. The 2D band is anticipated in layered graphitic carbon materials, particularly graphene. This band peak was also observed in the CNO, which suggests multilayered stacking of the ordered sp² carbon network.

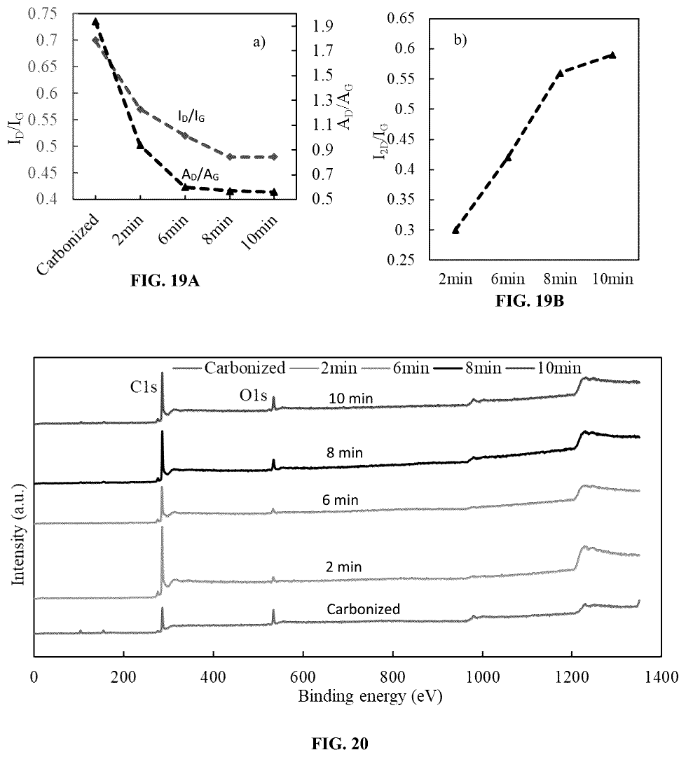

FIG. 19A shows the ratios of the relative intensities and peak areas of the D-band to the G-band (I_{D}/I_{G} and A_{D}/A_{G}) of OL-CNO as a function of treatment time (Jorio et al., “Measuring Disorder in Graphene With the G and D Bands,” Phys. Status Solidi Basic Res., 247(11-12):2980-2982 (2010); Zhang et al., “Carbon Nanostructure of Kraft Lignin Thermally Treated at 500 to 1000° C.,” Materials (Basel), 10(8):1-14 (2017); which are hereby incorporated by reference in their entirety). Both I_{D}/I_{G} (from 0.70 to 0.48) and A_{D}/A_{G} (from 1.94 to 0.56) values showed a decreasing order with the increase in treatment time, indicating CNO with greater graphitization degrees formed due to the development of shells made of sp² carbons. The presence of broad D-peak in the CNO is due to the spherical shape, edge defects, and curvature and closure of the graphitic planes of CNO (Tovar-Martinez et al., “Synthesis of Carbon Nano-onions Doped With Nitrogen Using Spray Pyrolisis,” Carbon N. Y. 140:171-181 (2018), which is hereby incorporated by reference in its entirety). The reported I_{D}/T_{G} ratio in this work is lower than that of CNOs prepared by other methods (Miriyala et al., “Synthesis of Carbon Onion and Its Application as a Porous Carrier For Amorphous Drug Delivery,” Crystals 10(4):281 (2020); Xin et al., “Fabrication of Ultra-bright Carbon Nano-onions Via a One-step Microwave Pyrolysis of Fish Scale Waste in Seconds,” Green Chem. 24:3969 (2022); Cabioc'h et al., “Fourier Transform Infra-red Characterization of Carbon Onions Produced by Carbon-ion Implantation,” Chem. Phys. Lett. 285(3-4):216-220 (1998); Zeiger et al., “Understanding Structure and Porosity of Nanodiamond-derived Carbon Onions,” Carbon N. Y. 84(1)584-598 (2015); Cebik et al., “Raman Spectroscopy Study of the Nanodiamond-to-carbon Onion Transformation,” Nanotechnology 24(20) (2013); McDonough et al., “Influence of the Structure of Carbon Onions on Their Electrochemical Performance in Supercapacitor Electrodes,” Carbon N. Y. 50(9):3298-3309 (2012); Omurzak et al., “Synthesis of Hollow Carbon Nano-onions Using the Pulsed Plasma in Liquid,” J. Nanosci. Nanotechnol. 15(5):3703-3709 (2015); Ventrella et al., “Synthesis of Green Fluorescent Carbon Dots From Carbon Nano-onions and Graphene Oxide,” RSC Adv. 10(60):36404-36412 (2020); which are hereby incorporated by reference in their entirety), suggesting CNOs with more ordered graphitic structures formed.

The I_{2D}/I_{G} ratios of OL-CNO plotted in FIG. 19B can be used to measure the overall quality of carbon structure. As shown, the I_{2D}/I_{G} ratio preliminary increases at 6 min and longer treatment times after CNO form due to the inclusion of a layered graphene structure with fewer defects (Mohapatra et al., “In situ Nitrogen-doped Carbon Nano-onions for Ultrahigh-rate Asymmetric Supercapacitor,” Electrochim. Acta 331:135363 (2020), which is hereby incorporated by reference in its entirety). The 2D peak shifts from 2622 cm⁻¹ to 2627 cm⁻¹ after the CNO starts to develop and planarize. A similar Raman trend similar also observed for KL-CNO and BC-CNO. The findings confirm that similar structural parameters can be obtained from different precursor sources. In this work, the joule heating treatment time had a greater impact than the precursor type. The Raman-based crystalline structure information of CNO produced using different precursors and treatment conditions is also included in Table 1.

### XPS Results

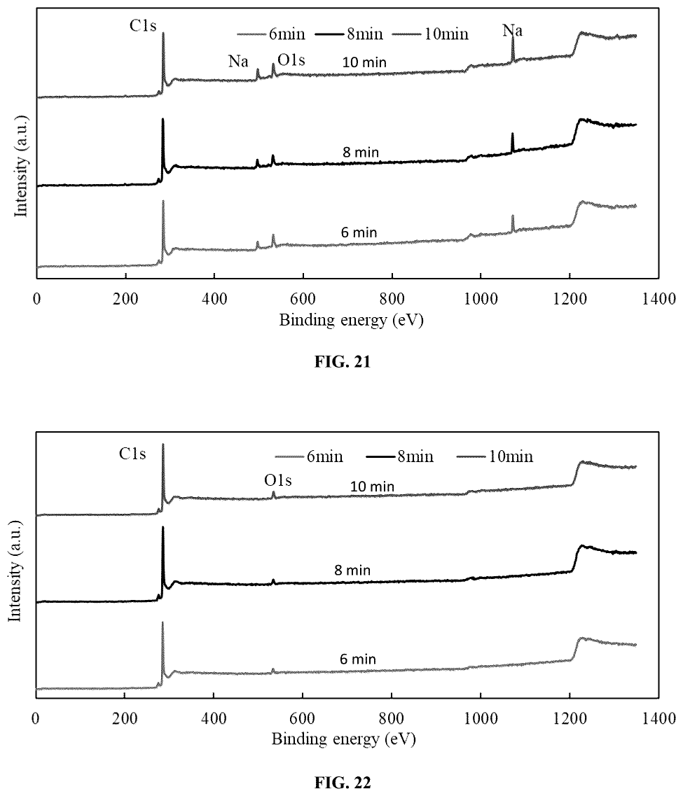

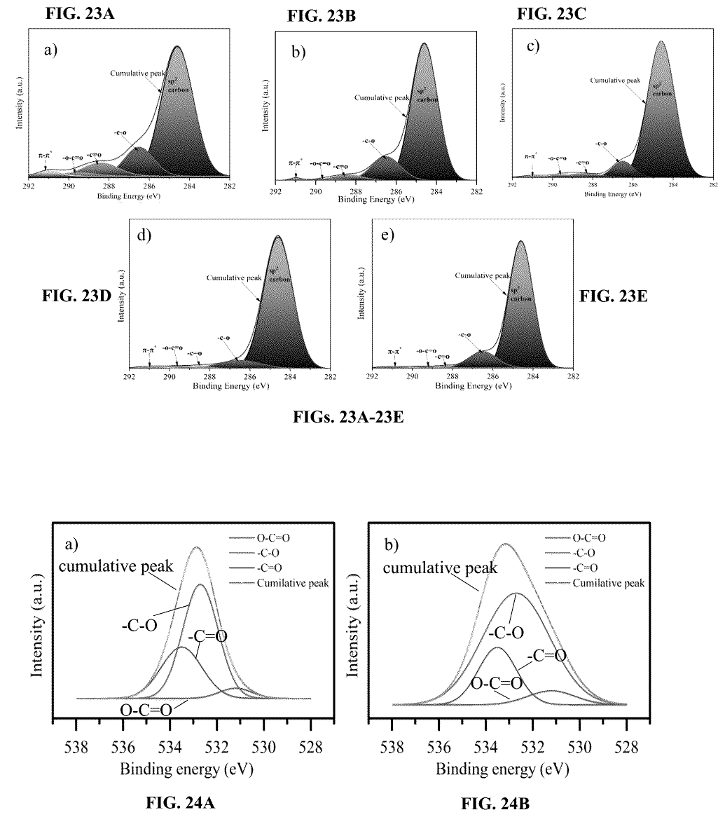

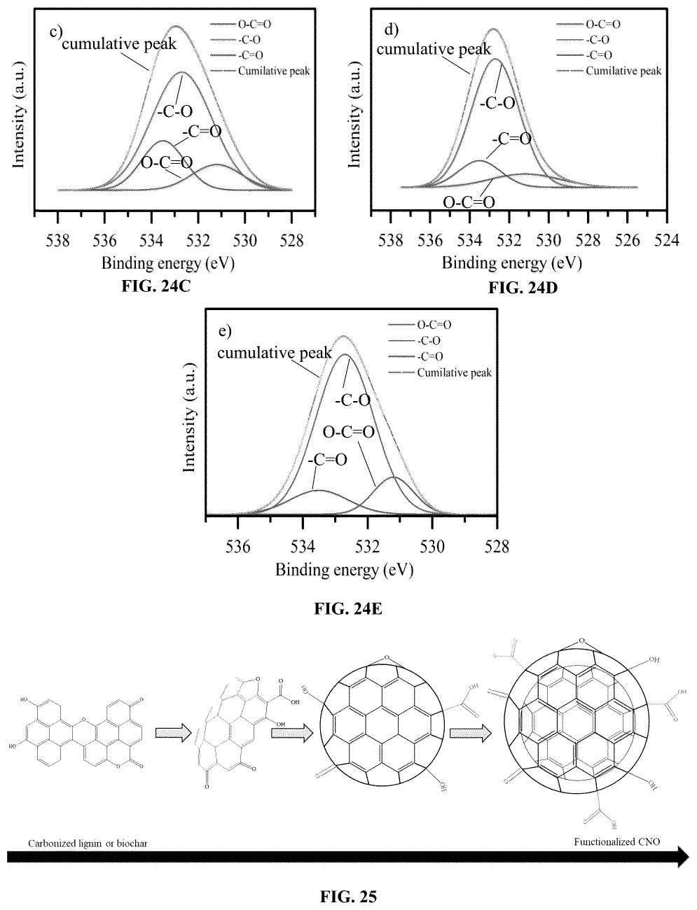

While the above results confirm the formation of graphitic CNO, their functional groups were investigated using XPS. Conventionally synthesized CNO often do not have surface functional groups, causing chemical incompatibility issues in their applications (Zeiger et al., “Review: Carbon Onions for Electrochemical Energy Storage,” J. Mater. Chem. A, 4:3172-3196 (2016); Chen et al., “New Method of Carbon Onion Growth by Radio-Frequency Plasma-Enhanced Chemical Vapor Deposition,” Chemical Physics Letters, 336:201-204 (2001); Dorobantu et al., “Pulse Laser Ablation System for Carbon Nano-Onions Fabrication,” Surface Engineering and Applied Electrochemistry, 50:390-394 (2014); Mongwe et al, “Synthesis of Chain-Like Carbon Nano-Onions by a Flame Assisted Pyrolysis Technique Using Different Collecting Plates,” Diamond and Related Materials, 90:135-143 (2018); Bagge-Hansen et al., “Detonation Synthesis of Carbon Nano-Onions via Liquid Carbon Condensation,” Nat Commun, 10:3819 (2019); Liu et al., “Carbon Nano-Onions Made Directly from CO₂ by Molten Electrolysis for Greenhouse Gas Mitigation,” Adv. Sustainable Syst., 3(10):1900056 (2019); Roddatis et al., “Transformation of Diamond Nanoparticles into Carbon Onions under Electron Irradiation,” Phys. Chem. Chem. Phys., 4:1964-1967 (2002); Rettenbacher et al., “Preparation and Functionalization of Multilayer Fullerenes (Carbon Nano-Onions),” Chemistry—A European Journal, 12:376-387 (2006); Du et al., “Onion-Like Fullerenes Synthesis from Coal,” Fuel, 86: 294-298 (2007); Garcia-Martin et al., “Method to Obtain Carbon Nano-Onions by Pyrolisys of Propane,” Open Physics, 11(11):1548-1558 (2013); which are hereby incorporated by reference in their entirety). FIGS. 20-22 show the survey scans of the fabricated CNOs with the existence of C1s (˜285 eV) peak and O1s (˜532 eV) peak, suggesting the formation of highly pure CNOs (Chen et al., “A Review on C1s XPS-spectra for Some Kinds of Carbon Materials,” Fullerenes Nanotub. Carbon Nanostructures, 28(12):1-11 (2020), which is hereby incorporated by reference in its entirety). The survey scan of KL-CNO shows a Na peak at around ˜1072 ev, which is attributed to Kraft process used to isolate lignin from parent biomass (Garcia-Negron et al., “Processing-Structure-Property Relationships for Lignin-Based Carbonaceous Materials Used in Energy-Storage Applications,” Energy Technology, 5(8):1311-1321 (2017), which is hereby incorporated by reference in its entirety). The survey scan shows a high-intensity C1s peak for OL-CNO compared to the pre-carbonized OL, suggesting a formation of graphite structure with oxygen functional groups. The XPS spectra for the C1s (OL-CNO in FIGS. 23A-23E as an example) peak were deconvoluted using the Gaussian peak fitting method into five peaks centered at 284.6, 286.5, 288.4, 289.5, and 291 eV, which correspond to the graphitic sp² Carbon, —C—O, —C═O, O—C═O, and π-π* stacking respectively (D. J. Morgan, “Comments on the XPS Analysis of Carbon Materials,” C 7(3):51 (2021), which is hereby incorporated by reference in its entirety). The expanded scans of O1s spectra were deconvoluted into three peaks, including O—C═O peak at ˜531.2 eV, —C—O peak at ˜532.7 eV, and —C═O peak at ˜533.5 eV (OL-CNO in FIGS. 24A-24E as an example), which also confirm oxygen-functionalized CNO. Table 2 summarizes the relative content of functional groups in different CNO. The graphitization during the joule heating treatment increased the content of sp² hybridized carbon. However, —C—O, —C═O, and O—C═O remained in CNO although their contents depended on joule heating time. Joule heating is expected to remove the side chain oxygenated functional groups in the pre-carbonized lignin or biochar, promoting polyaromatic carbons and graphene structures. On the other hand, the light oxygenated molecules (e. g., H₂O, CO₂, and CO) produced from the deoxygenation reactions as byproducts readily react with CNO at elevated temperatures, oxidizing the graphene carbons. In all precursor cases, sp² carbon increased, and oxygen-containing groups decreased until an 8 min treatment time, but they reversed trends when the treatment time was 10 min. As described above, increases of d₀₀₂ and decreases of L_{c} were also observed in the CNO treated for the same time. These results suggest that the degree of oxidation became stronger at prolonged treatment time, probably causing ring-opening reactions in CNO. FIG. 25 illustrates the proposed mechanism for the formation of functionalized CNO from lignin or biochar.

TABLE 2
XPS results of CNOs with different
precursors and synthesis conditions

| | sp²-carbon | —C—O | —C═O | O—C═O | π-π* |
|---|---|---|---|---|---|
| Sample | (%) | (%) | (%) | (%) | (%) |
| Carbonized OL | 72.51 | 14.90 | 8.24 | 2.14 | 2.22 |
| OL-2 min | 79.65 | 15.15 | 3.58 | 0.92 | 0.70 |
| OL-6 min | 86.52 | 8.00 | 2.98 | 1.53 | 0.98 |
| OL-8 min | 88.14 | 7.80 | 0.98 | 1.45 | 1.64 |
| OL-10 min | 83.73 | 12.88 | 0.93 | 1.19 | 1.28 |
| KL-6 min | 86.86 | 7.82 | 2.32 | 1.64 | 1.36 |
| KL-8 min | 85.80 | 9.17 | 1.99 | 1.93 | 1.11 |
| KL-10 min | 84.89 | 10.13 | 2.13 | 1.61 | 1.23 |
| BC-6 min | 90.24 | 7.19 | 1.20 | 0.83 | 0.54 |
| BC-8 min | 91.27 | 6.14 | 0.89 | 0.93 | 0.78 |
| BC-10 min | 88.16 | 8.49 | 1.69 | 0.93 | 0.72 |

### Solution Dispersion of CNOs

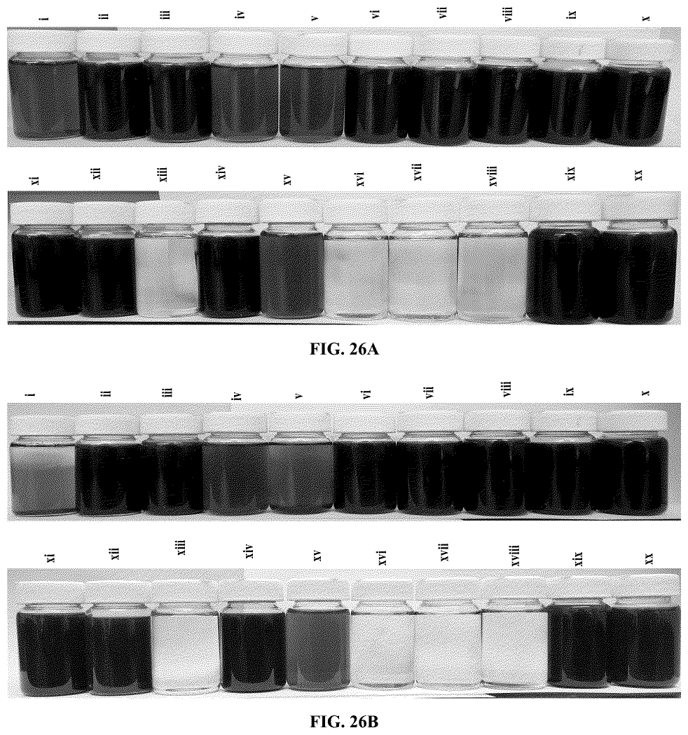

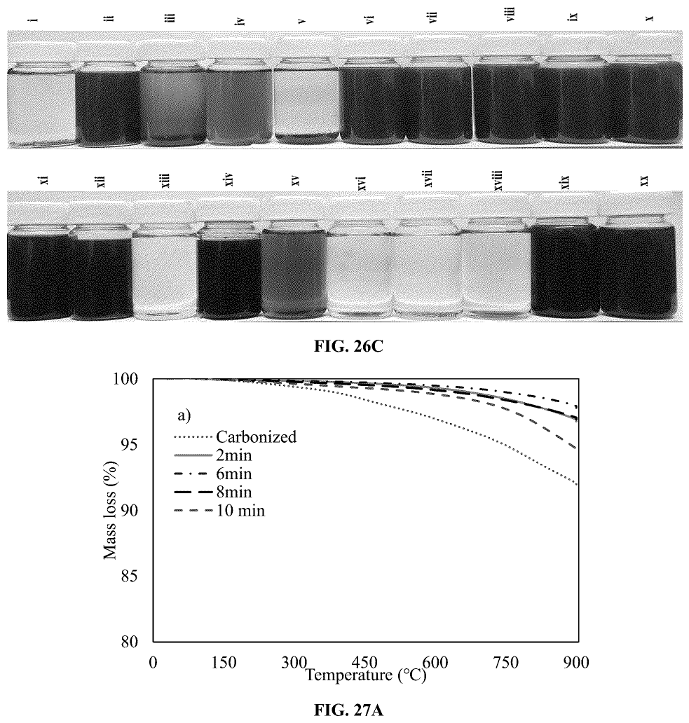

The above results show that the biobased CNOs have moderately crystallized multiple-shelled carbon structures with functionalized surfaces. Such structures are impossible to obtain with high-temperature thermal annealing of CND since the resulting CNO are highly crystallized without surface functional groups. Conventionally prepared pristine CNO often have poor dispersibility in solvents due to the lack of surface functionalities, which limits their applications (Dhand et al., “A Comprehensive Review on the Prospects of Multi-functional Carbon Nano Onions as an Effective, High-Performance Energy Storage Material,” Carbon N. Y., 175:534-575 (2021), which is hereby incorporated by reference in its entirety). Accordingly, CNOs were chemically modified in previous studies to improve solvent solubilities (Pdrez-Ojeda et al., “Carbon Nano-onions: Potassium Intercalation and Reductive Covalent Functionalization,” J. Am. Chem. Soc., 143(45):18997-19007 (2021); Molina-Ontoria et al., “Preparation and Characterization of Soluble Carbon Nano-onions by Covalent Functionalization, Employing a Na—K alloy,” Chem. Commun., 49(24):2406-2408 (2013); which are hereby incorporated by reference in their entirety). In comparison, CNO synthesized in this work using the joule heating process had tunable oxygen-functional groups, which were expected to improve solvent dispersibility. To confirm, OL-CNO (i.e., OL-6 min) was dispersed in 20 common solvents (17 polar and 3 hydrocarbon solvents) and the dispersion solutions were monitored for up to 2 weeks. As shown in FIG. 26, CNOs could be dispersed in all solvents except for 1,4-dioxane and hydrocarbon solvents. CNO showed excellent dispersion stability in acetone, tetrahydrofuran, dimethylformamide, N-methyl-2-pyrrolidone, dichloromethane, dimethyl sulfoxide, pyridine, diethyl ether, chloroform, ethylene glycol, and ethylene glycol monomethyl ether. CNO was also dispersible in water and alcohol solvents although the dispersion concentration was lower than the abovementioned solvents. The CNO with rich oxygen functional groups can increase surface energy, enabling their dispersion in various polar solvents. This dispersion characteristic shows the possibility of using CNOs in different applications, including filler material in polymer, electrodes for sensing, catalyst, and energy storage applications (Dhand et al., “A Comprehensive Review on the Prospects of Multi-functional Carbon Nano Onions as an Effective, High-performance Energy Storage Material,” Carbon N. Y., 175:534-575 (2021); Pdrez-Ojeda et al., “Carbon Nano-onions: Potassium Intercalation and Reductive Covalent Functionalization,” J. Am. Chem. Soc., 143(45):18997-19007 (2021); Molina-Ontoria et al., “Preparation and Characterization of Soluble Carbon Nano-onions by Covalent Functionalization, Employing a Na—K alloy,” Chem. Commun., 49(24):2406-2408 (2013); Mykhailiv et al., “Carbon Nano-onions: Unique Carbon Nanostructures With Fascinating Properties and Their Potential Applications,” Inorganica Chim. Acta 468:49-66 (2017); Ahlawat et al., “Application of Carbon Nano Onions in the Biomedical Field: Recent Advances and Challenges,” Biomater. Sci., 9(3):626-644 (2021); Plonska-Brzezinska and Echegoyen, “Carbon Nano-onions for Supercapacitor Electrodes: Recent Developments and Applications,” J. Mater. Chem. A, 1(44):13703-13714 (2013), which are hereby incorporated by reference in their entirety).

### Thermal Stability of CNOs

FIGS. 27A-27B show the representative TGA profiles of OL-CNO and Table 3 compares the thermal decomposition of OL-CNOs and KL-CNOs in air. Under a nitrogen environment, the mass loss of the carbonized OL at 900° C. was 8% (FIG. 27 A). The mass loss was 3-5% for the joule heating treated carbons with the OL-10 min showing the most mass loss among them. When heated under air (FIG. 27 B), the joule-heating treated carbons were much more stable than the carbonized lignin. As shown in Table 3, T_{d} (the temperature corresponding to 5% mass loss) and Tₘₐₓ (the temperature corresponding to the maximum mass loss rate) increased with the treatment time to reach a maximum at OL-8 min and decreased at the longer treatment time for OL-10 min. This thermal stability trend of CNO also corresponds to the increased d₀₀₂ spacing, decreased crystalline sizes (L_{c} and Lₐ), and increased oxygen functional groups in this CNO, indicating that excessive oxidation can partly rapture ring structures to reduce graphene carbons and the thermal stability of CNO.

TABLE 3
Thermal properties for OL-CNOs and KL-CNOs

| | OL | | | | | KL | | | |
|---|---|---|---|---|---|---|---|---|---|
| Precursor | | Joule heating | | | | | Joule heating | | |
| Conditions | Carbonized | 2 min | 6 min | 8 min | 10 min | Carbonized | 6 min | 8 min | 10 min |
| T_{d} (° C.) | 443.0 | 487.83 | 501.0 | 499.0 | 494.0 | 402.5 | 439.5 | 428.0 | 432.0 |
| Tₘₐₓ (° C.) | 530.5 | 547.5 | 636.5 | 664.6 | 622 | 506 | 520 | 522 | 521 |

### Electrical Conductivity of CNOs

The CNO was synthesized using the joule heating method in this work, indicating electrically conductive materials are formed. The electrical conductivity of CNO was measured during their synthesis based on the process voltage and current conditions. Neither carbonized lignins nor as-received biochar is electrically conductive. Although adding small amounts of carbon black could allow a weak current between two electrodes to initiate the joule heating, the electrical resistance of the precursors was still very high. As the joule heating heats the materials, carbonization reactions transform amorphous carbons of lignins or BC into ordered graphene carbons. The improved carbon structures of the treated samples, in turn, increased the electrical conductivity of the newly formed structures. This changing electrical property of the materials is evident in FIG. 2. Initially, the voltage remained at 32 V and the current increased with time due to reducing electrical resistance in the heated sample. When the current reached the preset upper limit of the current (4 A), the voltage dropped sharply to between 6.8 V and 7.2 V for different precursors to accommodate the increased electrical conductivity of the new carbon materials. However, the current and voltage did not change with increasing treatment time afterward, indicating that the electrical conductivity of CNO is agnostic to the joule heating time. The electrical conductivity calculated based on the stabilized voltage and current was 3.95 S/cm for OL-CNO, 3.89 S/cm for KL-CNO, and 3.73 S/cm for BC-CNO. The electrical conductivity range of the CNO synthesized from the CND annealing was reported to be 0.025-4 S/cm (Gu and Yushin, “Review of Nanostructured Carbon Materials for Electrochemical Capacitor Applications: Advantages and Limitations of Activated Carbon, Carbide-derived Carbon, Zeolite-templated Carbon, Carbon Aerogels, Carbon Nanotubes, Onion-like Carbon, and Graphene,” Wiley Interdiscip. Rev. Energy Environ., 3(5):424-473 (2014), which is hereby incoporated by reference in its entirety). Thus, the biobased CNO produced in this work has comparably high conductivity.

### Performance of CNO-Engineered PLA Composites

Various carbon materials, such as single or multiwall CNT, graphene, graphite, graphene oxide (GO), carbon fibers (CF), or their hybrids, have been used in polymers for improving mechanical, thermal, or gas/vapor barrier properties. However, CNO application for polymer property enhancers has yet to be explored. In this work, CNOs were explored as inexpensive additives for property-enhanced polymer using PLA as the polymer matrix.

### Mechanical Properties of PLA Composites

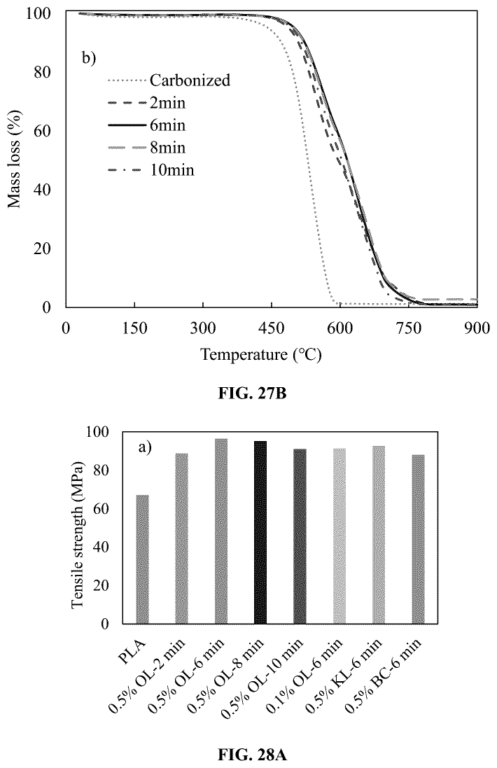

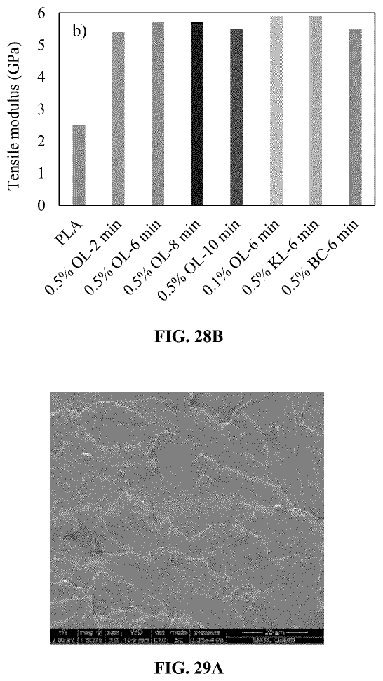

FIGS. 28A-28B compare the tensile properties of neat PLA and PLA composites containing different precursors derived CNO. The tensile strength and tensile modulus of the composites were higher than that of neat PLA in all cases. Among OL-CNO with different treatment times, OL-6 min resulted in maximum tensile property increases in PLA composites. The tensile strength and modulus of the composite containing 0.5% OL-6 min were 96.3 MPa and 5.7 GPa, respectively, equivalent to 43.7% and 128% increases compared to 67 MPa and 2.5 MPa for neat PLA. It also shows that adding merely 0.1% OL-6 min CNO could already improve the tensile strength and modulus of PLA composite to 91.5 MPa and 5.9 GPa, respectively. Therefore, PLA composites were also fabricated using KL-6 min and BL-6 min for comparison. The tensile strength of PLA composite containing 0.5% KL-6 min or 0.5% BC-6 min was 92.8 MPa and 88 MPa, respectively. The slightly lower property values are probably due to the higher ash contents in the corresponding CNO (i.e., 3.26% for KL-6 min and 2.65% for BC-6 min, compared to 0.96% for OL-6 min) caused by their precursor sources. The variation in the tensile properties of the PLA composites can be insignificant when the detrimental impact caused by the precursor impurities is accounted for. As described above, CNO produced from OL, KL, and BC had similar structures and properties despite their different biomass origin and methods for obtaining lignin or BC from their parent biomass. The results suggest that precursor agnostic CNO could be produced and applied.

Other mechanical properties of PLA composite containing OL-6 min were also measured, and the results are summarized in Table 4 to compare with the properties of neat PLA. In addition to improving tensile properties, 0.5% OL-6 min could increase PLA's flexural strength by 9.4%, flexural modulus by 20%, and impact strength by 60.4%. The mechanical property results of PLA composite containing 0.5% GNP were also included in the same table to evaluate the reinforcing effect of CNO compared to GNP. GNP is a nanocarbon of single or multilayer graphite plane (Liu et al., “Carbon Nano-Onions Made Directly from CO₂ by Molten Electrolysis for Greenhouse Gas Mitigation,” Adv. Sustain. Syst., 3(10):1900056 (2019), which is hereby incorporated by reference in its entirety). It is a commercial additive or filler used to improve the mechanical and other properties of polymers. Our results show that with the same mass loading of 0.5%, CNO outperformed GNP in increasing the tensile strength and modulus of PLA. It also shows that adding GNP reduces the flexural modulus of PLA and has nearly no effect on its impact strength. In comparison, adding CNO could simultaneously improve the tensile, flexural and impact properties of PLA. The results suggest that the biobased CNO is a higher-performing additive than GNP.

TABLE 4
Mechanical properties of PLA composites
with CNO or GNP as additives

| | Tensile properties | | Flexural properties | | Impact |
|---|---|---|---|---|---|
| | Strength | Modulus | Strength | Modulus | Strength |
| | (MPa) | (GPa) | (MPa) | (GPa) | (J/m) |
| PLA | 67 | 2.5 | 140.3 | 4.0 | 24.0 |
| 0.5% OL-6 min | 96.3 | 5.7 | 153.5 | 4.8 | 38.5 |
| 0.5% GNP | 90 | 5.7 | 135.9 | 3.7 | 25.7 |

### Interaction of CNO in PLA Composites Based on SEM and FTIR Results

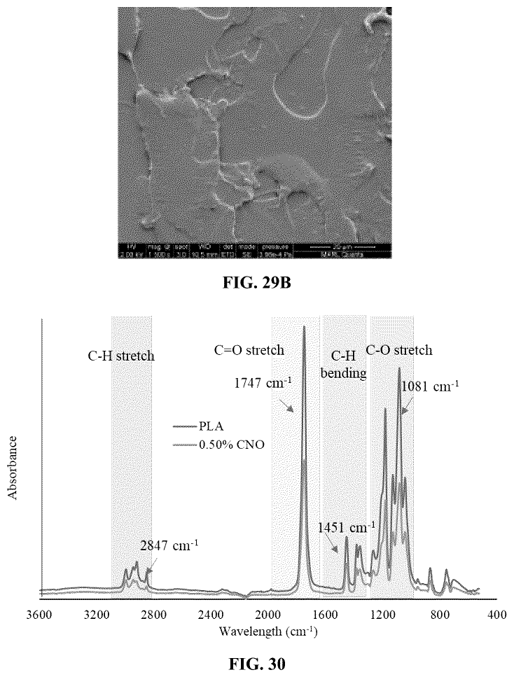

Reinforcement effects of CNT, GNP, or CF are well known since their unidirectional sp² carbon structures can effectively transfer mechanical load applied to the polymers (Papageorgiou et al., “Mechanisms of Mechanical Reinforcement by Graphene and Carbon Nanotubes in Polymer Nanocomposites,” Nanoscale, 12:2228-2267 (2020); Yao et al., “Recent Advances in Carbon-Fiber-Reinforced Thermoplastic Composites: A Review,” Composites Part B: Engineering, 142:241-250 (2018); which are hereby incorporated by reference in their entirety). Since the quasi-sphere CNO structures have zero dimension, CNOs were previously not considered in polymer reinforcement (Vindhyasarumi et al., “A Comprehensive Review on Recent Progress in Carbon Nano-Onion Based Polymer Nanocomposites,” European Polymer Journal, 194:112143 (2023), which is hereby incorporated by reference in its entirety). The unexpected and impressive high performance of CNOs as a reinforcing additive observed in this work could be attributed to the excellent comparability of the oxygen-functionalized CNOs in PLA. The rich oxygen functional groups in CNO can improve chemical compatibility with the polyester polymer to promote uniform dispersion of the nanoparticles in the polymer matrix. Agglomerated nanoparticles were nearly not noticeable in the SEM image of the fracture surface of the PLA-CNO tensile bar (FIGS. 29A-29B), confirming their high dispersibility in the polymer matrix. The functionalized CNO can also interact with PLA to create strong covalent or non-covalent bonding. For example, hydrogen bonding between oxygen-containing functional groups of CNOs and the ester group of PLA can enhance their interaction. The FTIR spectra of the PLA-CNO composite and neat PLA are compared to determine the chemical interaction. In FIG. 30, the intensities of the peaks shown in the ranges of 1000-1300 cm⁻¹ for C—O stretch, 1300-1460 cm⁻¹ for C—H bending, and 2800-3000 cm⁻¹ for C—H stretch, and the peak at 1747 cm⁻¹ for C═O stretch decreased noticeably in the PLA composite compared to PLA for analyzing the two samples with same masses. The decreased FTIR peak intensities are usually due to increased chemical bonding in the microstructure, requiring more energy to stretch or bend the bonds. Therefore, this result confirms strong chemical interactions between PLA and CNO in the composite (Mohamed et al., “Chapter 1—Fourier Transform Infrared (FTIR) Spectroscopy,” in Hilal, eds., Membrane Characterization, Amsterdam, Netherlands: Elsevier, pp. 3-29 (2017), which is hereby incorporated by reference in its entirety). The mechanically strong nanoparticles of turbostratic carbons well distributed and anchored in PLA polymer matrix via interfacial bonds are expected to provide strong structural support when mechanical forces are applied to the polymer.

### Thermal Properties of PLA Composite

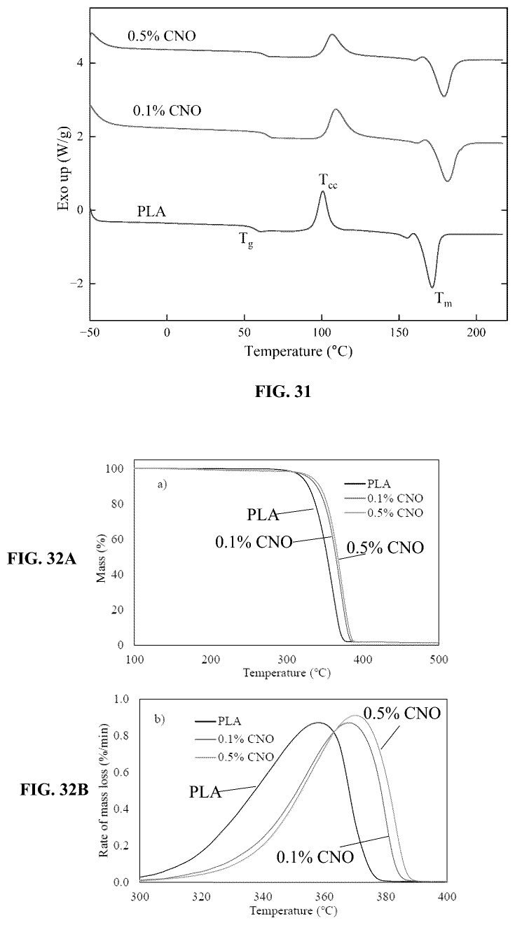

The effect of CNO additives on thermal properties of PLA was also evaluated. FIG. 31 shows the DSC thermograms of the PLA-CNOs. Thermal property analysis results are given in Table 5. Adding as low as 0.1 wt % OL-CNO can increase its glass transition temperature (T_{g}) from 57.1 to 64.4° C., and melting temperature (Tₘ) from 171.5 to 180.9° C. The increased T_{g} and Tₘ are due to the reduced molecular mobility of PLA, confirming good dispersion of CNOs and the strong interaction between PLA and CNOs. These improvements suggest that CNO additives could also be used to develop polymers suitable for higher temperature applications. On the other hand, the cold crystalization temperature (T_{cc}) increased from 100.8 to 109.6° C. This trend is opposite that of previously reported PLA reinforced with other carbon additives (Kim et al., “Exploration of hybrid nanocarbon composite with polylactic acid for packaging applications,” Int. J. Biol. Macromol., 144:135-142 (2020), which is hereby incorporated by reference in its entirety). Rather than acting as a nuclei site for promoting crystallization, the interactions between PLA and CNOs slowed down the crystallization of the polymer. PLA chains could be confined by CNOs, which can reduce crystalline growth (Wu et al., “Crystallization Behavior of Polylactide/Graphene Composites,” Ind. Eng. Chem. Res., 52(20):6731-6739 (2013), which is hereby incorporated by reference in its entirety). CNO addition also increased thermal decomposition temperature (T_{d}) from 319° C. with neat PLA to 328° C. by 0.1% loading, and 332.7° C. by 0.5% loading (the TGA and DTG profiles in FIGS. 32A-32B). With 0.5% CNOs, T_{g} and Tₘ increased by 6.3 and 12.2° C., respectively. These improvements suggest that CNOs as additives can enable higher-temperature applications of PLA.

TABLE 5
Thermal stability comparison of PLA-CNO
(T_{d}: the temperature for 5% mass loss,
Tₘₐₓ: the temperature for the maximum mass loss rate)

| Material | T_{g} (° C.) | T_{cc} (° C.) | Tₘ (° C.) | T_{d} (° C.) | Tₘₐₓ (° C.) |
|---|---|---|---|---|---|
| PLA | 57.1 | 100.8 | 171.5 | 319.0 | 358.0 |
| 0.1% OL-CNO | 64.4 | 109.6 | 180.9 | 328.0 | 368.2 |
| 0.5% OL-CNO | 63.4 | 106.9 | 179.2 | 332.7 | 370.2 |

### Oxygen and Water Vapor Barrier Properties of PLA-CNOs

Table 6 shows the oxygen transmission rate (OTR) and water vapor transmission rate (WVTR) of neat PLA and PLA-CNOs. Both OTR and WVTR of PLA decreased dramatically by introducing CNOs. The PLA with 0.5% OL-6 min reduced OTR by 67.4% and WVTR by 48.4% compared to neat PLA. The permeation and diffusion of gas and vapor molecules through the polymer's amorphous phase determine the oxygen and water-vapor barrier properties for semi-crystalline polymers like PLA (Valapa et al., “Effect of Graphene Content on the Properties of Poly(lactic acid) Nanocomposites,” RSC Adv., 5(36):28410-28423 (2015), which is hereby incorporated by reference in its entirety). The addition of impermeable materials in PLA restricts gases or vapors infiltration by forming a tangled channel and the tangled pathway forces the light molecular compounds to swing around, improving the barrier properties (Yang et al., “Poly(lactic acid)/lignin Films with Enhanced Toughness and Anti-oxidation Performance for Active Food Packaging,” Int. J. Biol. Macromol., 144:102-110 (2020), which is hereby incorporated by reference in its entirety). The well-distributed nanoparticles of CNO in the polymer matrix and the outstanding chemical compatibility of CNO and PLA could have played key roles in developing the tangled pathways which hinder gas transportation through the PLA film. The CNO-to-PLA interfacial interaction is significantly enhanced by the rich oxygen functional groups on the CNO surface, which can also positively impact the barrier characteristics. These findings unequivocally demonstrate the potential of biobased CNO in PLA for packaging applications, which can shield food products from oxidation by limiting the absorption of oxygen molecules and limiting water vapor transmission from the surroundings.

TABLE 6
Oxygen and water vapor permeability of PLA-CNOs

| Sample | OTR (cc/(m² · day)) | WVTR (cc/(m² · day)) |
|---|---|---|
| PLA | 210.57 | 38.61 |
| 0.1% OL-6 min | 210.61 | 28.27 |
| 0.5% OL-6 min | 68.76 | 19.91 |

### Performance of CNO Compared to Literature-Reported Carbon-Based Additives

As shown above, using a small quantity of CNOs as additives could significantly improve PLA's mechanical, thermal, and gas barrier properties altogether. Table 7 lists previously reported PLA composites reinforced by other carbon materials for comparison. Reinforced PLA composites have been extensively investigated as PLA is the most important biodegradable polymer. For example, Batakliev et al. added 6% of multi-wall CNT (MWCNT) to PLA to increase the tensile strength by 20% and tensile modulus by approximately 17% (Batakliev et al., “Effects of Graphene Nanoplatelets and Multiwall Carbon Nanotubes on the Structure and Mechanical Properties of Poly(lactic Acid) Composites: A Comparative Study,” Appl. Sci., 9(3):469 (2019), which is hereby incorporated by reference in its entirety). Gavali et al. added 15% CF to increase the tensile strength by 32%, flexural strength by 22%, and T_{g} by 3% (Gavali et al., “Mechanical and Thermo-mechanical Properties of Carbon fiber Reinforced Thermoplastic Composite Fabricated Using Fused Deposition Modeling Method,” Mater. Today Proc., 22:1786-1795 (2019), which is hereby incorporated by reference in its entirety). Their work achieved a 53% increase in impact strength by adding 20% CF. Gao et al. added 5% GNP to PLA to increase the tensile strength and tensile modulus by 41.3% and 23.7% (Gao et al., “Influence of Filler Size on the Properties of Poly(lactic Acid) (PLA)/Graphene Nanoplatelet (GNP) Nanocomposite,” Eur. Polym. J., 86:117-131 (2017), which is hereby incorporated by reference in its entirety). In another work by Park et al., 1% alkylated GO was added to increase the tensile strength and tensile modulus by 37.8% and 68.2%, respectively, and T_{g} by 3.3° C. (Park et al., “Melt Rheology and Mechanical Characteristics of Poly(Lactic acid)/Alkylated Graphene Oxide Nanocomposites,” Polymers (Basel)., 12(10):1-16 (2020), which is hereby incorporated by reference in its entirety). Kim and Jeong added 1% exfoliated graphite to increase the tensile strength of PLA by 9.3%, the tensile modulus by approximately 17%, and Td by 12° C. (Kim and Jeong, “Polylactide/exfoliated Graphite Nanocomposites with Enhanced Thermal Stability, Mechanical Modulus, and Electrical Conductivity,” J. Polym. Sci. Part B Polym. Phys., 48(8):850-858 (2010), which is hereby incorporated by reference in its entirety. Pinto et al. incorporated 0.4% GO or GNP into PLA film by solvent casting, increasing the tensile strength by 15% and tensile modulus by 85% (Pinto et al., “Effect of Incorporation of Graphene Oxide and Graphene Nanoplatelets on Mechanical and Gas Permeability Properties of Poly(lactic Acid) Films,” Polym. Int., 62(1):33-40 (2013), which is hereby incorporated by reference in its entirety). The T_{g} and Tₘ increased by 4.4 and 1.5° C. for 0.4% GO and 6.3 and 0.5° C. for 0.4% GNP. In their study, OTR decreased by 67.3% for 0.4% GO and 68.1% for 0.4% GNP. Kim et al. synthesized a GOCNT hybrid via exfoliation mixing in solvent and subsequently prepared PLA nanocomposites with GOCNT (Kim et al., “Exploration of Hybrid Nanocarbon Composite with Polylactic Acid for Packaging Applications,” Int. J. Biol. Macromol., 144:135-142 (2020), which is hereby incorporated by reference in its entirety). They reported that 0.4% GOCNT increased tensile strength by 75%, tensile modulus by 130%, and decreased OTR by 67%. However, T_{g} and Tₘ decreased by 1° C. and 0.2° C. by adding GOCNT. The comparison with the previous studies shows that the oxygen-functionalized CNOs synthesized as disclosed herein are far superior to other carbon additives or fillers to significantly improve the mechanical (tensile, bending, and impact) performance, thermal tolerance, and (oxygen and water vapor) barrier properties of PLA altogether using a very small quantity.

TABLE 7
Performance of PLA-CNOs compared to previous results of PLA with
other carbon materials

| | | | Processing | | |
|---|---|---|---|---|---|
| Matrix | Filler type | Filler loading | method | Results | Ref. |
| PLA | CNOs | 0.1 and 0.5% | Solution mixing | With 0.5% mass | This |
| | | | followed by | loading, tensile strength | work |
| | | | injection molding | and tensile modulus | |
| | | | | increased by 43.7% and | |
| | | | | 128% respectively. | |
| | | | | Flexural strength and | |
| | | | | modulus increased by | |
| | | | | 9.4% and 20%, and | |
| | | | | impact strength | |
| | | | | increased by 60.4%. Tg | |
| | | | | and Tm increased by 6.3° | |
| | | | | C. and 8.7° C., and T_{d} | |
| | | | | increased by 14° C. | |
| | | | | OTR decreased by 68% | |
| | | | | and WVTR decreased | |
| | | | | by 48%. | |
| PLA | Exfoliated | 0.05 and 0.2% | In-situ | Tensile strength and | 1 |
| | graphene | | polycondensation | tensile modulus | |
| | | | with melt | increased by 6% and | |
| | | | extrusion | 5%, and T_{d} increased by | |
| | | | | 7.7° C. with 0.2% | |
| | | | | loading. | |
| PLA | Exfoliated | 0.1-7.0% | Melt- | Tensile strength and | 2 |
| | graphite | | compounding | tensile modulus | |
| | | | | increased by 9.3% and | |
| | | | | tensile modulus | |
| | | | | increased by ~17% with | |
| | | | | 1% loading. T_{g} increased | |
| | | | | by 12° C. | |
| PLA | Exfoliated | 0.05 and 0.2% | Reactive | Tensile strength and | 3 |
| | graphene | | extrusion | tensile modulus | |
| | | | | increased by 19% and | |
| | | | | 32% with 0.05% | |
| | | | | loading, and 6% and 7% | |
| | | | | with 0.2% loading. T_{g} | |
| | | | | and Tm increased with 1 | |
| | | | | and 1.5° C. with 0.05% | |
| | | | | loading, and 1 and 1.1° | |
| | | | | C. with 0.2% loading, T_{d} | |
| | | | | increased by 12.8 or 7.8° | |
| | | | | C. with 0.05% or 0.2% | |
| | | | | loading. | |
| PLA | Expandable | 0.1-0.5% | Solution casting | Tensile strength | 4 |
| | graphite | | | increased by 25% for | |
| | | | | 0.1% loading. | |
| | | | | At this condition, T_{g} and | |
| | | | | Tₘ increased by 1 and 4 | |
| | | | | C., Td increased by 2° C., | |
| | | | | and OTR was reduced | |
| | | | | by 22%. | |
| PLA | MWCNTs | 1, 3, 5 and 10% | Melt extrusion | Tensile strength | 5 |
| | | | followed by | increased by 60.9% with | |
| | | | rolling process | 1% loading when the | |
| | | | | rolling ratio is 75%. At | |
| | | | | this condition, T_{g} and Tₘ | |
| | | | | decreased by 0.2 and 3.3° | |
| | | | | C. | |
| PLA | MWCNTs | 0.1-2% | Melt | Tensile strength, | 6 |
| | | | compounding | elongation at break, and | |
| | | | followed by hot | impact strength | |
| | | | pressing | increased by 8.4%, | |
| | | | | 49.3% and 78.7% for | |
| | | | | 0.5% loading. T_{d} | |
| | | | | increased by 10° C. | |
| PLA | Thermally | 0.1% | One-step ring- | Tensile strength | 7 |
| | reduced | | opening | increased by 8.9%. T_{d} | |
| | Graphene | | polymerization | decreased by 32K. | |
| | (TRG) | | | | |
| PLA | Alkylated | 0.1-2% | Solution blending | Tensile strength and | 8 |
| | graphene | | and coagulation | tensile modulus | |
| | oxide | | process | increased by 37.8% and | |
| | (AGO) | | | 68.2%, and Tg by 3.3° C. | |
| | | | | with 1% loading. | |
| PLA | Alkylated | 0.2-1% | Solution blending | Tensile strength and | 9 |
| | graphene | | and casting | tensile modulus | |
| | nanosheets | | | increased by 34% and | |
| | | | | 44% with 0.4% loading. | |
| PLA | Graphene | 0.2% | Solution casting | Tensile strength and | 10 |
| | nanosheets | | | tensile modulus | |
| | | | | increased by 26% and | |
| | | | | 18%. | |
| | | | | Td increased by 11° C. | |
| PLA | GNP | 5-10% | Melt | Tensile strength and | 11 |
| | | | compounding | tensile modulus | |
| | | | | increased by 16.1% or | |
| | | | | 10.1% for 5% long | |
| | | | | GNP. Tensile modulus | |
| | | | | increased by 55.9% with | |
| | | | | 10% loading but tensile | |
| | | | | strength decreased by | |
| | | | | 33.5%. Impact strength | |
| | | | | increased by 52% with | |
| | | | | 20% CF loading, but | |
| | | | | tensile strength | |
| | | | | decreased by 2.6% | |
| PLA | Carbon fiber | 12, 15, and 20 | Fused deposition | Tensile strength | 12 |
| | (CFs) | wt % | | increased by 32% and | |
| | | | | flexural strength | |
| | | | | increased by 22% with | |
| | | | | 15% CF. Impact strength | |
| | | | | decreased by 32% for | |
| | | | | 15% CFs loading. | |
| | | | | Impact strength | |
| | | | | increased by 52% with | |
| | | | | 20% CF. | |
| PLA | GNP | 0-9 wt % | Melt blending | Tensile strength and | 13 |
| | MWCNT | | | tensile modulus | |
| | | | | increased by 20% and | |
| | | | | approximately 23% with | |
| | | | | 6% MWCNT. Tensile | |
| | | | | strength and tensile | |
| | | | | modulus decreased with | |
| | | | | the incorporation of | |
| | | | | GNP. | |
| PLA | Functionalized | 1% of f-GNP | Solution casting | Tensile strength and | 14 |
| | CNTs | 1% of f-CNTs | | tensile modulus | |
| | Funcyionalized | | | increased by 15.6% and | |
| | GNP | | | 32.4% with 1% f-GNP, | |
| | | | | 40.1% and 54.3% with | |
| | | | | 1% f-CNTs. | |
| | | | | Td increased by 20K | |
| | | | | and 11K with the same | |
| | | | | materials. | |
| PLA | GO | 0.2-1% | Solvent casting | Tensile strength and | 15 |
| | GNP | | | tensile modulus | |
| | | | | increased by 15.4% and | |
| | | | | 63.2% with 0.4% GO or | |
| | | | | 0.4% GNP. | |
| | | | | OTR decreased by 67% | |
| | | | | with 0.4% GNP. | |
| PLA | GO/CNT | 0.05-0.4% | Solution casting | Tensile strength and | 16 |
| | | | | tensile modulus | |
| | | | | increased by 75% and | |
| | | | | 130%, and OTR | |
| | | | | increased by 67% with | |
| | | | | 0.4% of GOCNT hybrid. | |
| | | | | Tg and Tm decreased by | |
| | | | | 1° C. and 0.2° C. | |

References, which are hereby incorporated by reference in their entirety:
1. Chakraborty et al., “Facile Dispersion of Exfoliated Graphene/PLA Nanocomposites via In Situ Polycondensation with a Melt Extrusion Process and Its Rheological Studies,” J. Appl. Polym. Sci., 135(33):1-11 (2018)
2. Kim and Jeong, “Polylactide/Exfoliated Graphite Nanocomposites with Enhanced Thermal Stability, Mechanical Modulus, and Electrical Conductivity,” J. Polym. Sci. Part B Polym. Phys., 48(8):850-858 (2010)
3. Chakraborty et al., “Investigating the Properties of Poly(lactic acid)/Exfoliated Graphene Based Nanocomposites Fabricated by Versatile Coating Approach,” Int. J. Biol. Macromol., 113:1080-1091 (2018)
4. Valapa et al., “Effect of Graphene Content on the Properties of Poly(lactic acid) Nanocomposites,” RSC Adv., 5(36):28410-28423 (2015)
5. Wang et al., “Mechanical and Electrical Properties of Polylactic Acid/Carbon Nanotube Composites by Rolling Process,” IEEE J. Sel. Top. Quantum Electron., 25(5):891-901 (2018)
6. Zhou et al., “Preparation and Characterization of Polylactic Acid (PLA) Carbon Nanotube Nanocomposites,” Polym. Test., 68:34-38 (2018)
7. Tong et al., “Fabrication of Graphene/Polylactide Nanocomposites with Improved Properties,” Compos. Sci. Technol., 88:33-38 (2013)
8. Park et al., “Melt Rheology and Mechanical Characteristics of Poly(Lactic Acid)/Alkylated Graphene Oxide Nanocomposites,” Polymers (Basel)., 12(10):1-16 (2020)
9. Zhang et al., “Strong and Ductile Poly(lactic acid) Nanocomposite Films Reinforced with Alkylated Graphene Nanosheets,” Chem. Eng. J., 264:538-546 (2015)
10. Cao et al., “Preparation of Organically Dispersible Graphene Nanosheet Powders through a Lyophilization Method and Their Poly(lactic acid) Composites,” Carbon N. Y., 48(13):3834-3839 (2010)
11. Gao et al., “Influence of Filler Size on the Properties of Poly(lactic acid) (PLA)/Graphene Nanoplatelet (GNP) Nanocomposite,” Eur. Polym. J., 86:117-131 (2017)
12. Gavali et al., “Mechanical and Thermo-mechanical Properties of Carbon Fiber Reinforced Thermoplastic Composite Fabricated Using Fused Deposition Modeling Method,” Mater. Today Proc., 22:1786-1795 (2019)
13. Batakliev et al., “Effects of Graphene Nanoplatelets and Multiwall Carbon Nanotubes on the Structure and Mechanical Properties of Poly(lactic acid) Composites: A Comparative Study,” Appl. Sci., 9(3):469 (2019)
14. Rostami et al., “Graphene Induced Microstructural Changes of PLA/MWCNT Biodegradable Nanocomposites: Rheological, Morphological, Thermal and Electrical Properties,” RSC Adv., 6(55):49747-49759 (2016)
15. Pinto et al., “Effect of Incorporation of Graphene Oxide and Graphene Nanoplatelets on Mechanical and Gas Permeability Properties of Poly(lactic acid) Films,” Polym. Int., 62(1):33-40 (2013)
16. Kim et al., “Exploration of Hybrid Nanocarbon Composite with Polylactic Acid for Packaging Applications,” Int. J. Biol. Macromol., 144:135-142 (2020)

### Scalability of CNOs and Energy Input

The presented joule heating method for producing CNOs is simple, fast, and has high product yields. The yield for CNOs produced by joule heating is around 95% for OL-CNO, around 93% for KL-CNO, both per the pre-carbonized lignin, and 90% for BC-CNO per as-received biochar. The presented joule heating method for synthesizing CNOs can be scaled easily by simply enlarging the reactor size and adjusting the voltage and current limits of the power electric source. The energy required for producing BC-CNOs was 15.6 MJ/kg for 6 min treatment. It has been reported that the energy consumption for producing carbon materials was 100,000 MJ/kg for carbon nanotubes (Arvidsson et al., “Prospective Life Cycle Assessment of Graphene Production by Ultrasonication and Chemical Reduction,” Environ. Sci. Technol. 48(8):4529-4536 (2014), which is hereby incorporated by reference in its entirety), 44 MJ/kg for carbon black, 100-900 MJ/kg for carbon fiber (Khayyam et al., “Improving Energy Efficiency of Carbon Fi Ber Manufacturing Through Waste Heat Recovery: A Circular Economy Approach With Machine Learning,” Energy 225:120113 (2021), which is hereby incorporated by reference in its entirety). The recent low-energy syntheses of GNP by others reported the energy consumption of 7.2-14.4 MJ/kg (Luong et al., “Gram-scale Bottom-up Flash Graphene Synthesis,” Nature 577(7792) (2019); Osazuwa and Kontopoulou, “Graphene Nanoplatelets Derived From Thermomechanical Exfoliation of Graphite,” 1:1-6, (2019); which are hereby incorporated by reference in their entirety). Other than the low energy consumption, the solvent, chemical, catalyst-free process presented herein also uses cheap precursors, which can significantly reduce the production costs of CNOs. Considering biomass residues have low material costs and the joule heating process requires electricity only, the costs of the biobased CNOs are expected to be very low. Using biochar as the precursor of CNOs is especially attractive. In biomass pyrolysis, the process energy is used to convert biomass into bio-oil as the primary product. The carbon-condensed biochar obtained as a byproduct can be directly used in the joule heating reactor for producing CNOs.

### CONCLUSIONS

Although CNOs have versatile applications, their widespread uses are hindered by their extremely high costs attributed to the petroleum-based precursors and the costly synthesis method. In this work, a simple joule heating method was developed to obtain low-cost biobased CNOs with tunable oxygen functional groups from lignins and biochar in high yields (95%), without catalyst, solvents, or harsh chemicals. Benefiting from their turbostratic graphene structures rich in surface functional groups, the CNOs showed high electrical conductivity and excellent solvent dispersion. When added to the polymer matrix, as low as 0.1-0.5 wt % of CNOs significantly increased mechanical, thermal, and gas barrier properties of PLA, suggesting the CNO-engineered PLA nanocomposites are useful in many advanced polymer applications. The energy consumption of synthesizing CNOs by the joule heating method was low, which demonstrates that biobased CNOs could be produced at significantly lower costs than conventional CNOs. This work shows a promising pathway to valorize biomass residues for producing highly attractive nanocarbon materials.

### Example 2—Polylactic Acid-Wood-Carbon Nano-Onion (PLA-RO-CNO) Composites Based on Melt Extrusion

### Materials and Methods

### Materials

Polylactic Acid (PLA) Ingeo 2500HP was purchased from NatureWorks LLC (Minnetonka, Minnesota). Red Oak (RO) chips were milled with a planetary ball mill and then sieved into particles with a mesh size <70 m. Biobased carbon nano-onions (CNO) were synthesized in house from a softwood organosolv lignin based on the joule heating method described in Example 1.

### PLA-RO-CNO Bio-Composite Fabrication

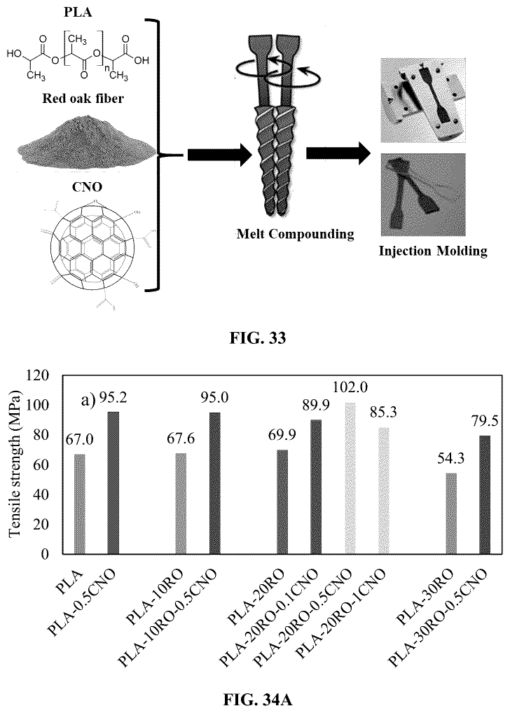

PLA-RO-CNO composite was fabricated using two-step processes, including twin screw extrusion and injection molding. Prior to the extrusion process, PLA, RO, and CNO were vacuum-dried overnight to remove any form of moisture. Before mixing with PLA, RO and CNO were premixed by grinding their mixture in a mortar and pestle for 30 mins. The PLA, RO, and CNO mixture was subjected to a twin-screw extrusion process at 220° C. and 180 rpm. The mixture was compounded for 5 min to prepare a homogeneous blend. A similar extrusion process was applied for neat PLA, PLA-CNO, and PLA and RO mixture. The extruded samples were processed in an injection molder at 220° C. to prepare composites. FIG. 33 shows the schematic of the composite fabrication process. Table 8 lists the composition of composites prepared. For comparison, PLA-RO composites without CNO or PLA-CNO without RO were also prepared.

TABLE 8
Composition and Code Name of the Fabricated Bio-composite

| | Composition (wt %) | | |
|---|---|---|---|
| Sample | PLA | Red Oak (RO) | CNO |
| PLA | 100 | 0 | 0 |
| PLA-0.5CNO | 100 | 0 | 0.5 |
| PLA-10RO | 90 | 10 | 0 |
| PLA-20RO | 80 | 20 | 0 |
| PLA-30RO | 70 | 30 | 0 |
| PLA-10RO-0.5CNO | 90 | 10 | 0.5 |
| PLA-20RO-0.1CNO | 80 | 20 | 0.1 |
| PLA-20RO-0.5CNO | 80 | 20 | 0.5 |
| PLA-20RO-1CNO | 80 | 20 | 1 |
| PLA-30RO-0.5CNO | 70 | 30 | 0.5 |

### Results

### Tensile Properties

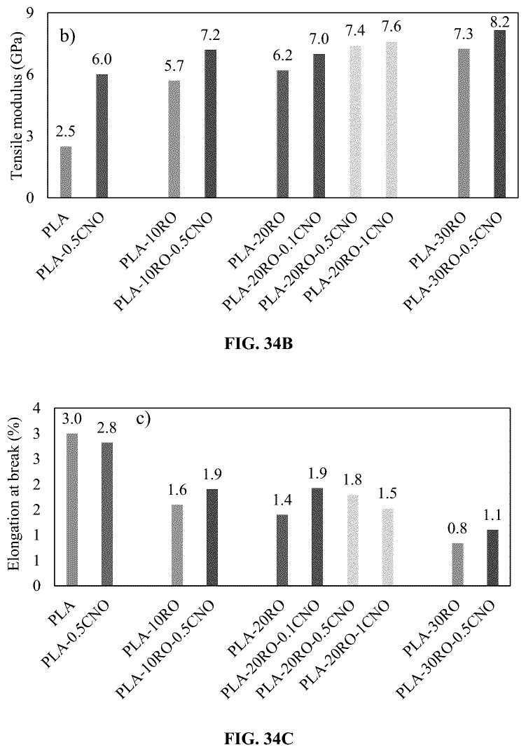

FIGS. 34A-34C compare the tensile properties of PLA, PLA-RO composites with different RO mass loading, and PLA-RO-CNO composites. Adding 10% RO has a minor effect on tensile strength, while 20% RO slightly increased the tensile strength to 69.9 MPa from 67 MPa for neat PLA. However, adding 30% RO content significantly decreased the tensile strength to 54.3 MPa. Adding RO to PLA improved tensile modulus of PLA-RO composites (FIG. 34B), but also caused significant decreases in the elongation-at-break (FIG. 34C). The incompatibility between PLA matrix and RO fiber, especially with increasing RO content, is responsible for the decreased tensile strength and increased brittleness of the composites.

The addition of CNO was found to significantly improve the tensile strength (FIG. 34A) and modulus (FIG. 34B) of composites. Impregnating 0.5% CNO to PLA in addition to RO led to significant increases in the tensile strength to 95 and 102 MPa, respectively for of PLA-10RO-0.5CNO and PLA-20RO-0.5CNO, which are 40.5% and 45.9% higher than the corresponding PLA-RO composites without CNO. Although the tensile strength of PLA-30RO-0.5CNO was lower at 79.5 MPa, it was still 46.4% and 18.7% higher than that of PLA-30RO and neat PLA. The effect of CNO mass loading was evaluated by also adding 0.1 and 1% of CNO to PLA and 20% RO. While the tensile strength increases were observed in all cases, 0.5% was the optimal CNO loading for obtaining the maximum tensile strength.

Incorporating CNO in addition to RO further improved the tensile modulus of composites. The tensile modulus of PLA-10RO-0.5CNO, PLA-20RO-0.5CNO, and PLA-30RO-0.5CNO were 7.2, 7.4, and 8.2 GPa, respectively, corresponding to 26.3, 19.4, and 13.9% increases compared to the corresponding PLA-RO composites. It also showed that the tensile modulus increases with the CNO loading.

Adding CNO to neat PLA slightly reduced the elongation-at-break from 3 to 2.8. However, PLA-RO-CNO composites showed higher elongation at break than PLA-RO composites. This increase suggests CNO may act as a compatibilizer or interface modifier to promote stronger interaction among the PLA, RO, and CNO. The oxygen-functional groups in the CNO may have facilitated a strong hydrogen bonding of the CNO with PLA and RO.

### Impact Properties

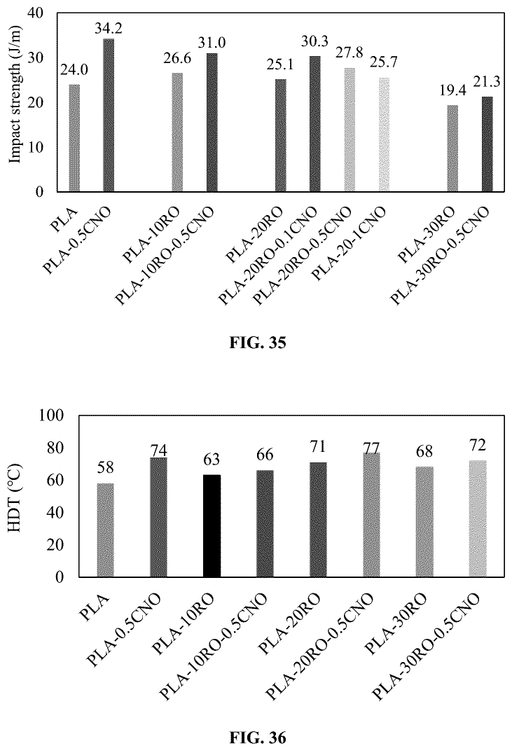

FIG. 35 compares the impact strength of PLA and composites. Adding up to 20% RO slightly increased the impact strength of PLA-RO. However, increasing its loading to 30% caused a decrease in the impact strength from 24 J/m for neat PLA to 19.4 J/m for PLA-30RO. This decrease in impact strength can be attributed to the decrease in the PLA chain mobility, confirmed by the reduction in the elongation at the break of the same composites. On the other hand, the incorporation of CNO had a positive effect on all composite matrices for improving their toughness. The impact strength of PLA-0.5CNO was 34.2 J/m compared to 24 J/m for neat PLA. The impact strength of PLA-10RO-0.5CNO. PLA-20RO-0.5CNO, and PLA-30-0.5 CNO was 31, 27.8 and 21.3 J/m, respectively, which are 16.5%, 10.8 and 9.8% higher than for the corresponding PLA-RO composites. It also showed that lower CNO loading had a more profound effect on increasing the impact strength of the composites. Higher CNO content may increase nanoparticle agglomeration in the composite matrices, weakening its reinforcing effects.

### Heat Distortion Temperature (HDT)

FIG. 36 shows the HDT of PLA and composites. HDT of neat PLA was 58° C., which is in line with the literature. The HDT increased to 74° C. in PLA-0.5 CNO, showing CNO addition can significantly improve the HDT of PLA. Adding RO fiber into PLA could also increase HDT. Among PLA-RO composites, the optimum HDT of 71° C. was observed with PLA-20RO. Incorporating CNO into the blends of PLA and RO could further improve the HDT with a maximum HDT of 77° C. observed for PLA-20RO-0.5CNO, which is 19° C. higher than neat PLA.

### Surface Morphology

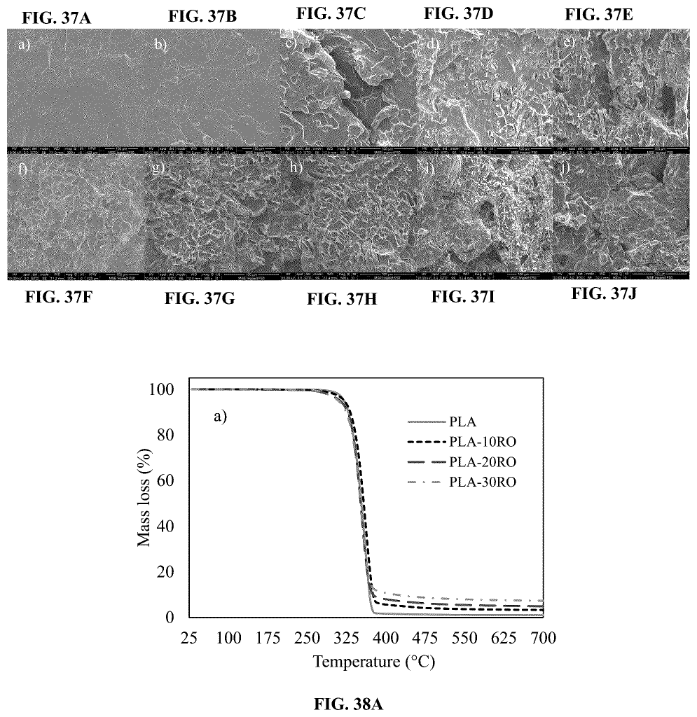

FIGS. 37A-37J show the SEM images of the tensile fractured surfaces of the PLA composites. Neat PLA showed a relatively smooth fracture surface, which is expected from its inherent brittleness. Nanoparticle agglomeration was not observed in the fractured surface of PLA-0.5CNO, suggesting good dispersion of CNOs in PLA. Rich functional groups in CNO can enhance the chemical compatibility between CNO and the polyester polymer, facilitating the homogeneous dispersion of the nanoparticles. Large voids were observed in PLA-RO composites. The voids are formed during the tension testing due to RO fibers pulled out from the fiber-matrix interface. Weak adhesion between the RO fibers and PLA matrix led to debonding and reduced mechanical performance of the composites.

Compared to PAL-CNO, there were significant decreases in void size and RO fiber pullout in PLA-RO-CNO composites. Fiber breakage rather than fiber pullout was observed, suggesting the presence of CNO enhanced the interface bonding of RO and the PLA matrix to improve stress transfer. The interface adhesion was improved, probably due to the uniform dispersion of the functionalized CNO that could promote durable covalent or non-covalent bonding with both PLA and RO. For instance, hydrogen bonds in the oxygen-functionalized CNO, and the ether and ester groups present in the PLA and RO can interact to form an improved interface between the hydrophobic PLA matrix and hydrophilic RO fiber. According to the XPS result reported in applicant's previous work, CNO contains a unique type of hydrophobic π-π* domain in the basal plane and hydrophilic carboxyl groups on the surface of the CNO. Consequently, CNO demonstrates an amphiphilic nature and thus serves as a compatibilizer for immiscible mixtures or composites of hydrophilic fillers and hydrophobic polymers.

### Thermal Properties

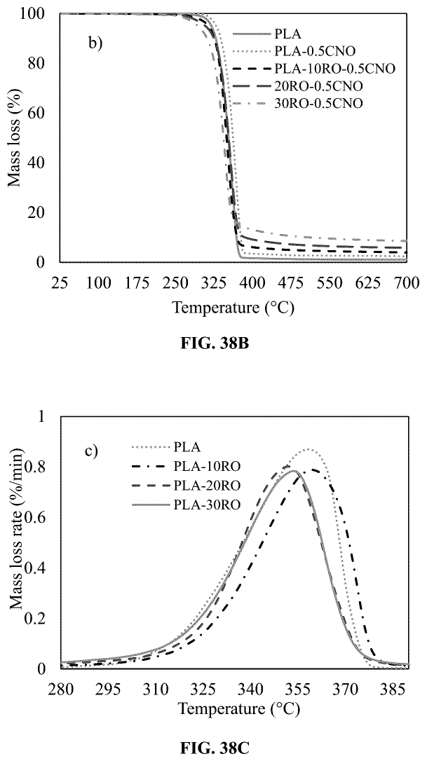

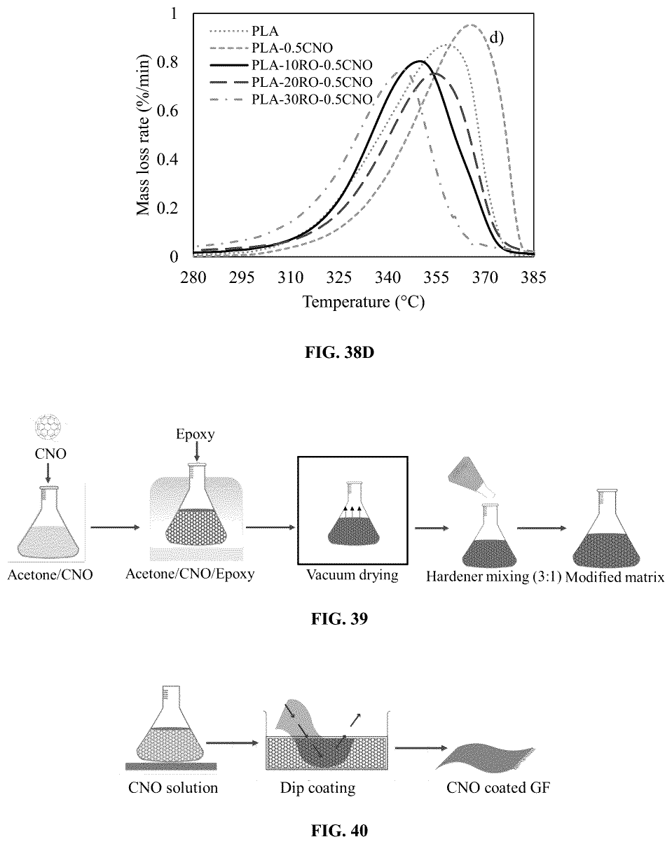

FIGS. 38A-38D show TGA and DTG curves of PLA and composites. Compared to neat PLA, thermal decomposition temperature (T_{d}) and the temperature for maximum mass loss rate (Tₘₐₓ) increased for PLA-10RO but decreased with further increasing RO contents. This is due to the lower thermal stability of RO than PLA. Adding CNO to neat PLA improved T_{d} and Tₘₐₓ of PLA-0.5CNO by 10.4° C. and 7° C., respectively. The increases are due to the highly thermally stable CNO uniformly dispersed in the PLA matrix. It was found that T_{d} and Tₘₐₓ decreased in PLA-RO-CNO composites compared to PLA-RO composites. The decrease in the decomposition temperature can be attributed to the catalytic effect of CNO on the thermal decomposition of RO. Catalytic effects of functionalized nanocarbons, for example, graphene oxide, have been reported in previous studies. In this study, the oxygen functional groups and high surface areas of CNO, as well as evenly distributed nanoparticles revealed by SEM images, may have enhanced their interaction with RO fibers in the composites.

On the other hand, it was also found that PLA-RO-CNO composites produce more char residues than neat PLA or PLA-RO composites. This finding suggests a strong interaction between CNO and RO in the polymer matrix promotes char-forming carbonization reactions. The increased char formation may correspond to improved fire retardancy of a material, as char can serve as a physical barrier to restrict oxygen penetration and formation of combustible elements, thereby limiting the tendency of the material for combustion. While further studies are needed, CNO could potentially be used as a biobased safe fire retardant.

TABLE 9
Comparison of TGA and DSC results of the bio-composites

| Sample | T_{d} (° C.) | Tₘₐₓ (° C.) | Char residue (%) |
|---|---|---|---|
| PLA | 319.0 | 358.0 | 1.01 |
| PLA-0.5CNO | 332 | 365.0 | 2.41 |
| PLA-10RO | 320.5 | 360.0 | 3.28 |
| PLA-10RO-0.5CNO | 314.5 | 351.0 | 3.94 |
| PLA-20RO | 312.7 | 354.5 | 4.89 |
| PLA-20RO-0.5CNO | 308.5 | 355.0 | 5.83 |
| PLA-30RO | 308.1 | 353.5 | 7.33 |
| PLA-30RO-0.5CNO | 293.6 | 345.5 | 8.57 |

### Example 3—Carbon Nano-Onion Reinforced Epoxy/Glass Fiber Composite

### Materials and Methods

### Methods

In this work, a bisphenol-A based epoxy from Fiberglast, USA (Epoxy 2000), a low viscosity curing agent 2120 Epoxy Hardener (Fibreglast, USA) and E-glass fiber (Style 7781 E-glass, Fiberglast, USA) were employed. Carbon nano onion (CNO) was used as synthesized using Joule heating as described in Example 1.

### Composite Fabrication

In this work, two approaches were employed to prepare composites. In the first approach, epoxy resin was modified with the CNO. As shown in FIG. 39, different amounts of CNO were dispersed in acetone and ultrasonicated for 1.5 hours in an ice bath. The epoxy was added in the acetone and CNO mixture and again sonicated for another 1.5 hours. The mixture was vacuum dried overnight to remove acetone. The curing agent was added in a 3:1 volume ratio of the epoxy to curing agent using a high-speed shear mixture at 2000 rpm for 5 min. Subsequently, the mixture was placed in a vacuum oven for 30 min to remove volatiles. The glass fiber (GF) was then coated by the CNO-modified epoxy using hand layup method and then the composite laminates was pre-cured at room temperature for 8 hours and finally post-cured in a carver hot press at 80° C. overnight.

In the second approach, a solution of 0.1 mg/ml CNO in acetone was prepared by ultrasonicating the solution for 1.5 hours (FIG. 40). GF was dip coated in the solution for 30 min. The CNO coated GF was dried overnight. The CNO coated GF was coated with unmodified epoxy to prepare laminates as described above.

As a control case, unmodified epoxy and GF were used to prepare a composite.

### Tensile Testing

For tensile testing, the composite was cut into a dimension of 80×20 mm with a thickness of 2 mm. The tensile test was performed in an Instron 3369 tensile tester equipped with a 50 kN load cell and tests were performed according to ASTM D3039 standard.

### Results

### Tensile Properties

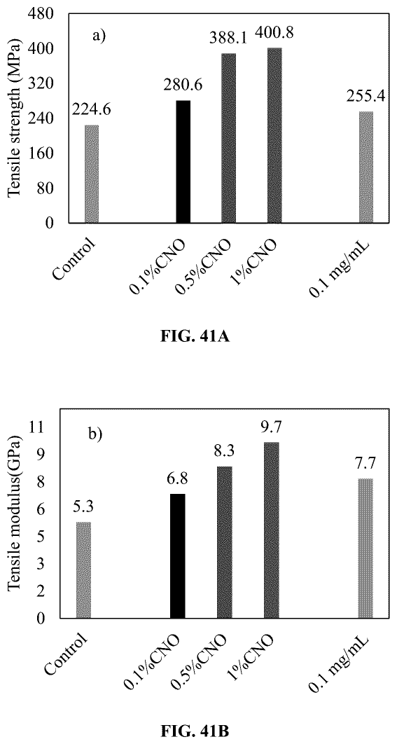

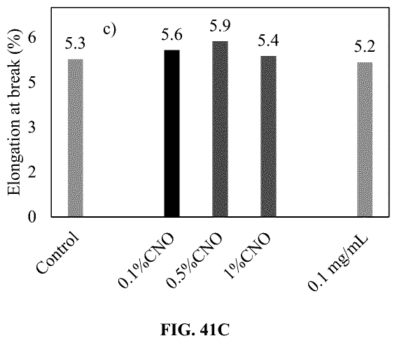

Tensile properties of the composites with different CNO mass loadings fabricated using the first approach was compared in FIG. 41A-41C. It can be observed that both tensile strength and modulus of the composite increased significantly with the increase in CNO mass loading. The tensile strength increased from 24.9 to 78.4% compared to control composite when 0.1 to 1% CNO. Similarly, tensile modulus increased from 29.1 to 82.7% for the same composite compared to control composite. It was also found that elongation at break for the composite increased in the CNO modified composites. These results suggest that uniform dispersion of functionalized CNO can develop strong bonds in the epoxy-GF matrix to provide significant reinforcing effects.

The tensile properties of the composite prepared using the second approach are also compared in FIGS. 41A-41C. Tensile strength and modulus were increased by 13.7% and 45.2%, respectively, compared to control sample. However, a slight decrease in elongation at break was observed.

Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

1. A carbon nano-onion comprising a structure comprising:
a plurality of substantially concentric carbon shells, said substantially concentric carbon shells having a spherical, quasi-spherical, and/or polyhedral configuration or combinations thereof, wherein said substantially concentric carbon shells have surfaces functionalized with oxygen-containing functional groups.

2. The carbon nano-onion of claim 1, wherein said carbon nano-onion is prepared by joule heat treatment of a fixed carbon-containing source.

3. The carbon nano-onion of claim 2, wherein the fixed carbon-containing source comprises biomass.

4. The carbon nano-onion of claim 3, wherein the biomass comprises lignin, biochar, a fixed carbon-containing biomass, or mixtures thereof.

5. The carbon nano-onion of claim 4, wherein the biomass comprises lignin selected from Hardwood Kraft Lignin (HKL), Softwood Kraft Lignin (SKL), Oragnosolv Hardwood Lignin, Oragnosolv Softwood Lignin, Herbaceous biomass-derived lignin, Acetosolv Lignin, Milled Wood Lignin (MWL), steam-explosion lignin, plasma-extraction lignin, chemically modified lignins, or combinations thereof.

6. The carbon nano-onion of claim 1, wherein each of the plurality of substantially concentric carbon shells is spaced about 0.3 nm to about 0.4 nm from an adjacent carbon shell.

7. The carbon nano-onion of claim 1, wherein the plurality of substantially concentric carbon shells are in the form of spherical graphitic layers.

8. The carbon nano-onion of claim 1, wherein the plurality of substantially concentric carbon shells are in the form of quasi-spherical graphitic layers.

9. The carbon nano-onion of claim 1, wherein the plurality of substantially concentric carbon shells are in the form of polyhedral graphitic layers.

10. The carbon nano-onion of claim 1, wherein the carbon nano-onion structure comprises a stacked turbostratic form.

11. The carbon nano-onion of claim 1, wherein the plurality of substantially concentric carbon shells comprise sp² hybridized carbons.

12. The carbon nano-onion of claim 1, wherein the oxygen-containing functional groups comprise ethers, esters, carboxylic acids, ketones, aldehydes, or combinations thereof.

13. A composite material comprising:
the carbon nano-onion of claim 1 and
a polymer mixed with said carbon nano-onion.

14. The composite material of claim 13, wherein the polymer comprises a thermoplastic polymer selected from the group consisting of a plastic, polylactic acid, polyamide 6 (PA6), polyhydroxyalkanoates (PHAs), polyesters, polyethylene (PE), polypropylene (PP), polystyrene, polyvinyl chloride, and combinations thereof.

15. (canceled)

16. The composite material of claim 12, wherein the polymer comprises a thermoset polymer selected from the group consisting of an epoxy resin, Triglycidyl p-amino-phenol, diglycidyl ester of hexahydrophthalic acid, epoxycresol novolak, epoxyphenol novolak, and combinations thereof.

17.-18. (canceled)

19. The composite material of claim 13, further comprising:
a synthetic fiber and/or a natural fiber.

20. The composite material of claim 19 comprising a synthetic fiber, wherein the synthetic fiber is fiberglass.

21. The composite material of claim 19 comprising a natural fiber, wherein the natural fiber is wood.

22.-32. (canceled)

33. A method of preparing an oxygen-functionalized carbon nano-onion, said method comprising:
providing a fixed carbon-containing source and
treating the fixed carbon-containing source by joule heating under conditions effective to transform the fixed carbon-containing source into an oxygen-functionalized carbon nano-onion comprising a plurality of substantially concentric carbon shells, said substantially concentric carbon shells having a spherical, quasi-spherical, and/or polyhedral configuration or combinations thereof.

34.-45. (canceled)

46. A method of preparing a composite material, said method comprising:
providing the carbon nano-onion of claim 1;
blending a polymer with the carbon nano-onion to form a mixture; and
forming a composite material from the mixture.

47.-70. (canceled)
